(19) United States
(12) Patent Application Publication
(10) Pub. No.: US 2020/0233829 A1
(43) Pub. Date: Jul. 23, 2020

(54) MULTI-LANE SYSTEM POWER MANAGEMENT INTERFACE

(71) Applicant: QUALCOMM Incorporated, San Diego, CA (US)

(72) Inventors: Dilin VALIPARAMBIL DIVAKAR, Bangalore (IN); Christopher Kong Yee CHUN, Austin, TX (US)

(21) Appl. No.: 16/254,189

(22) Filed: Jan. 22, 2019

(51) Int. Cl. G06F 13/42; G06F 1/26

(52) U.S. Cl. CPC G06F 13/4282; G06F 2213/0002; G06F 1/26

(57) ABSTRACT

Systems, methods, and apparatus related to the operation of a multilane serial bus communicate the configuration of lanes used to handle a transaction over the serial bus through signaling transmitted at the commencement of the transaction. The method includes asserting a multilane bus request by initiating a pulse on a secondary data lane of the serial bus while the clock lane is idle, participating in a first bus arbitration procedure executed using the secondary data lane after the pulse is terminated, providing initial signaling on the secondary data lane after winning the first bus arbitration procedure to indicate a set of data lanes to be used during a transaction, and executing a first transaction using the set of data lanes. The set of data lanes may include the primary data lane and the secondary data lane. The initial signaling may include a sequence start condition.

### TECHNICAL FIELD

The present disclosure relates generally to serial communication and input/output pin configuration and, more particularly, to providing additional data lanes in system power management interface.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a serial bus or a parallel bus. General-purpose serial interfaces known in the industry, including the Inter-Integrated Circuit (I2C or I²C) serial bus and its derivatives and alternatives, including interfaces defined by the Mobile Industry Processor Interface (MIPI) Alliance, such as the I3C interface, the system power management interface (SPMI), and the Radio Frequency Front-End (RFFE) interface.

In one example, the I2C serial bus is a serial single-ended computer bus that was intended for use in connecting low-speed peripherals to a processor. Some interfaces provide multi-master buses in which two or more devices can serve as a bus master for different messages transmitted on the serial bus. In another example, the RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single integrated circuit (IC) device, or provided in multiple IC devices. In a mobile communications device, multiple antennas and radio transceivers may support multiple concurrent RF links.

In many instances, a number of command and control signals are employed to connect different component devices in mobile communication devices. These connections consume precious general-purpose input/output (GPIO) pins within the mobile communication devices and it would be desirable to replace the physical interconnects with signals carried in information transmitted over existing serial data links.

As mobile communication devices continue to include a greater level of functionality, improved serial communication techniques are needed to support low-latency transmissions between peripherals and application processors.

### SUMMARY

Certain aspects of the disclosure relate to systems, apparatus, methods and techniques that can provide optimized low-latency communications between different devices such that GPIO signals may be carried as virtual signals.

In various aspects of the disclosure, a method performed at a device coupled to a serial bus that has a clock lane and a primary data lane includes asserting a multilane bus request by initiating a pulse on a secondary data lane of the serial bus while the clock lane is idle, participating in a first bus arbitration procedure executed using the secondary data lane after the pulse is terminated, providing first signaling on the secondary data lane after winning the first bus arbitration procedure to indicate a set of data lanes to be used during a following transaction, and executing a first transaction using the set of data lanes. The set of data lanes may include the primary data lane and the secondary data lane.

In one aspect, the method includes asserting a single-lane bus request by initiating a pulse on the primary data lane after the first transaction has been completed, participating in a second bus arbitration procedure executed using the primary data lane after the pulse is terminated, and executing a second transaction using the primary data lane.

In certain aspects, the method includes providing second signaling on at least one additional data lane while providing the first signaling on the secondary data lane and executing the first transaction by transmitting a data payload using two or more channels, each channel including one or more data lanes. The first signaling may include a first sequence start condition (SSC), and the second signaling may include a second SSC. The method may include configuring the two or more channels based on an enumeration of the secondary data lane and the at least one additional data lane. The method may include interleaving one or more frames in the data payload over one or more data lanes of at least one channel. The method may include transmitting a first portion of the data payload over a first channel to a first receiving device coupled to the serial bus, and transmitting a second portion of the data payload over a second channel to a second receiving device coupled to the serial bus.

In certain aspects, the method includes initiating a pulse on the primary data lane while initiating the pulse on the secondary data lane. The presence of pulses on the primary data lane and the secondary data lane indicates that the multilane bus request is a high-priority request. The set of data lanes may include a maximum number of data lanes available for executing the first transaction in response to the high-priority request. Executing the first transaction may include transmitting virtualized general-purpose input/output state.

In various aspects of the disclosure, an apparatus has a processor and a bus interface coupled to a serial bus that has a clock lane and a primary data lane. The processor may be configured to assert a multilane bus request by causing the interface circuit to initiate a pulse on a secondary data lane of the serial bus while the clock lane is idle, participate in a first bus arbitration procedure executed using the secondary data lane after the pulse is terminated cause the interface circuit to provide a first SSC on the secondary data lane after winning the first bus arbitration procedure to indicate a set of data lanes to be used during a transaction, and execute a first transaction using the set of data lanes. The set of data lanes includes the primary data lane and the secondary data lane.

In various aspects of the disclosure, a processor-readable storage medium has instructions stored thereon which, when executed by at least one processor or state machine of a processing circuit, cause the processing circuit to assert a multilane bus request by initiating a pulse on a secondary data lane of the serial bus while the clock lane is idle, participate in a first bus arbitration procedure executed using the secondary data lane after the pulse is terminated, provide a first SSC on the secondary data lane after winning the first bus arbitration procedure to indicate a set of data lanes to be used during a transaction, and execute a first transaction using the set of data lanes. The set of data lanes includes the primary data lane and the secondary data lane.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates an example of a system employing one or more SPMI buses that may be adapted in accordance with certain aspects disclosed herein.

FIG. 4 illustrates an example of a system which includes one or more communication links that employ sideband GPIO.

FIG. 5 illustrates the use of a serial bus to communicate virtual GPIO state in accordance with certain aspects disclosed herein.

FIG. 6 illustrates apparatus that can generate and process virtual GPIO state in accordance with certain aspects disclosed herein.

FIG. 7 illustrates a system configured to communicate some combination of messages and virtual GPIO using multiple data lanes in accordance with certain aspects disclosed herein.

FIG. 8 illustrates a multi-lane SPMI bus implemented in accordance with certain aspects disclosed herein.

FIG. 9 illustrates a first example of data flow through a multi-lane interface that is operated in accordance with certain aspects disclosed herein.

FIG. 10 illustrates an example of timing of two SPMI transactions executed through the multi-lane interface illustrated in FIG. 9.

FIG. 11 illustrates a second example of data flow through a multi-lane interface that is operated in accordance with certain aspects disclosed herein.

FIG. 12 illustrates an example of timing of an SPMI transaction executed through the multi-lane interface illustrated in FIG. 11.

FIG. 13 illustrates a third example of data flow through a multi-lane interface that is operated in accordance with certain aspects disclosed herein.

FIG. 14 illustrates an example of timing of a high-priority SPMI transaction executed through the multi-lane interface illustrated in FIG. 13.

FIG. 15 illustrates a fourth example of data flow through a multi-lane interface that is operated in accordance with certain aspects disclosed herein.

FIG. 16 illustrates one example of an apparatus employing a processing circuit that may be adapted according to certain aspects disclosed herein.

FIG. 17 is a third flowchart illustrating certain operations of device adapted in accordance with certain aspects disclosed herein.

FIG. 18 illustrates an example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a shared communication interface that may include a serial bus or other data communication link to connect processors with modems and other peripherals. The serial bus or other data communication link may be operated in accordance with multiple standards or protocols defined. In various examples, a serial bus may be operated in accordance in with a I2C protocol, I3C protocol, SPMI protocol and/or RFFE protocol. The serial bus may be deployed to handled high volume, high-priority and/or low-latency data. In one example, the state of GPIO pins may be virtualized to obtain high-priority messages that are intended to be transmitted with low-latency over the serial bus. Bus capacity may be increased by adding data lanes to more rapidly transfer bulk data such that bus congestion is reduced when high-volume data is exchanged over the serial bus.

A number of different protocol schemes may be used for communicating messaging and data over communication links. Existing protocols have well-defined and immutable structures in the sense that their structures cannot be changed. In some examples, a serial communication bus that is operated in accordance with I2C, I3C, SPMI, RFFE, or other standards or protocols may be used to tunnel different protocols with different register and data format requirements, different data transmission volumes and/or different transmission schedules.

Certain aspects disclosed herein provide methods, circuits and systems that relate to the operation of a multilane serial bus. In some aspects, the configuration of lanes used to handle a transaction over the serial bus may be configured through signaling transmitted at the commencement of the transaction. In one example, a multilane bus request may be initiated by a device seeking access to the bus by initiating a pulse on a secondary data lane of the serial bus while the clock lane is idle. The device may participate in a bus arbitration procedure executed after the pulse is terminated. After winning the bus arbitration procedure, the device may use a secondary data lane of the serial bus transmit signaling that indicates a set of data lanes to be used during a following transaction. The signaling indicating data lanes to be used may be transmitted at the commencement of the transaction and/or concurrently with a transmission that initiates a transaction. The transmission may be a start condition, for example.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

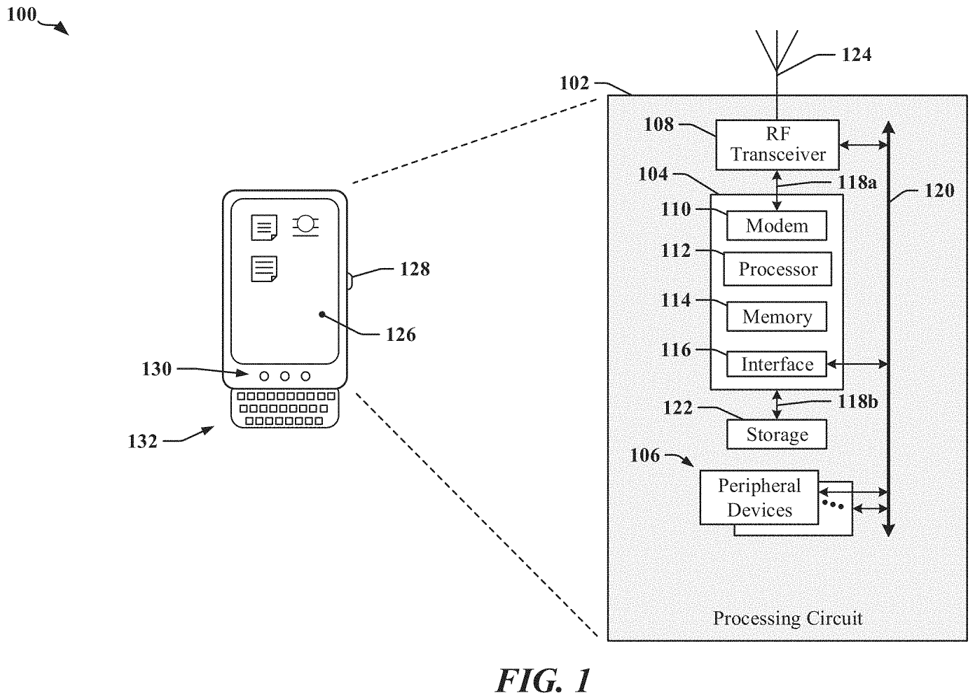

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

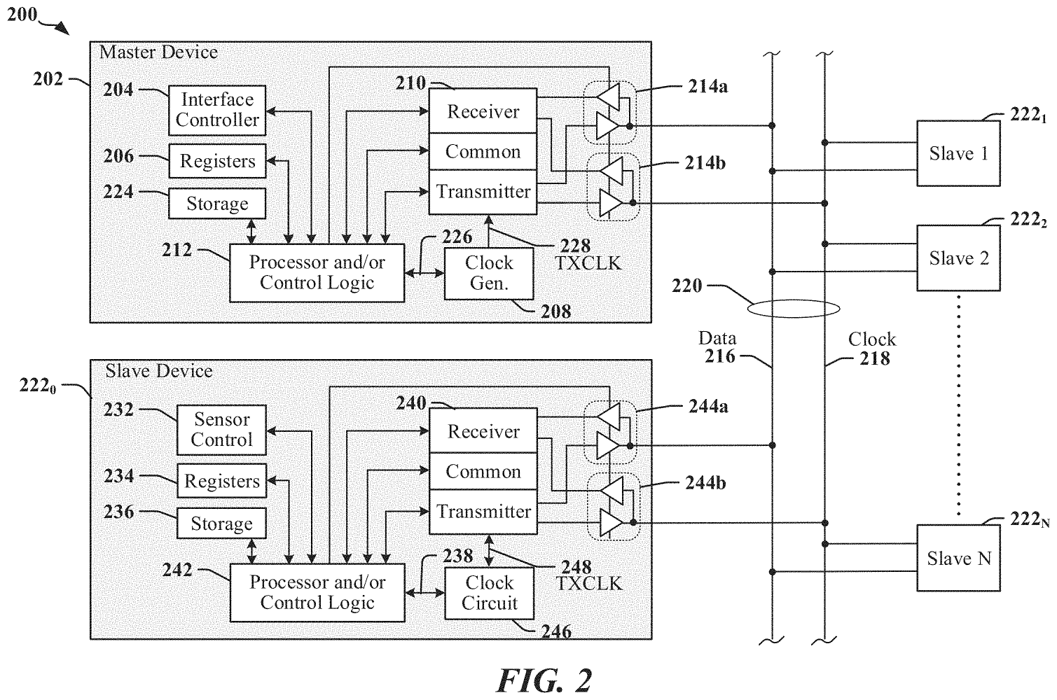

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as applications processors, SoCs or ASICs. In various implementations the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communications between devices 202 and 222₀-222_{N} over the serial bus 220 is controlled by a bus master device 202. Certain types of bus can support multiple bus masters.

In one example, a bus master device 202 may include an interface controller 204 that may manage access to the serial bus, configure dynamic addresses for slave devices 222₀-222_{N} and/or generate a clock signal 228 to be transmitted on a clock line 218 of the serial bus 220. The bus master device 202 may include configuration registers 206 or other storage 224, and other control logic 212 configured to handle protocols and/or higher level functions. The control logic 212 may include a processing circuit such as a state machine, sequencer, signal processor or general-purpose processor. The bus master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ configured to operate as a slave device may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit such as a state machine, sequencer, signal processor or general-purpose processor. The transceiver 210 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 248 may be derived from a signal received from the clock line 218. Other timing clocks 238 may be used by the control logic 242 and other functions, circuits or modules.

The serial bus 220 may be operated in accordance with I2C, I3C, SPMI, RFFE, and/or other protocols. A bus master manages communication over the serial bus 220, and typically provides a clock signal that is used to control timing of transmissions. In various examples, one or more devices may be capable of operating as a bus master and devices may contend for control of the serial bus 220 in order to conduct a transaction. In the illustrated example, a bus master device 202 may execute a transaction with one or more slave devices 222₀-222_{N} coupled to the serial bus 220.

In an example where the serial bus 220 is operated in accordance with an I3C protocol, devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define certain electrical and timing aspects of signals transmitted on the serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, a 2-wire serial bus 220 transmits data on a data line 216 and a clock signal on the clock line 218. In some instances, data may be encoded in the signaling state, or transitions in signaling state of the data line 216 and the clock line 218.

Bus latency can affect the ability of a serial bus to handle high-priority, real-time and/or other time-constrained messages. Low-latency messages, or messages requiring low bus latency, may relate to sensor status, device-generated real-time events and virtualized general-purpose input/output (GPIO). In one example, bus latency may be measured as the time elapsed between a message becoming available for transmission and the delivery of the message or, in some instances, commencement of transmission of the message. Other measures of bus latency may be employed. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

Multi-drop interfaces such as I3C, SPMI, RFFE, etc. can reduce the number of physical input/output (I/O) pins used to communicate between multiple devices. Protocols that support communication over a multi-drop serial bus define a datagram structure used to transmit command, control and data payloads. Datagram structures for different protocols define certain common features, including addressing used to select devices to receive or transmit data, clock generation and management, interrupt processing and device priorities. In this disclosure, the example of SPMI and RFFE protocols may be employed to illustrate certain aspects disclosed herein. However, the concepts disclosed herein are applicable to other serial bus protocols and standards. Some similarities exist between SPMI and RFFE datagram structures.

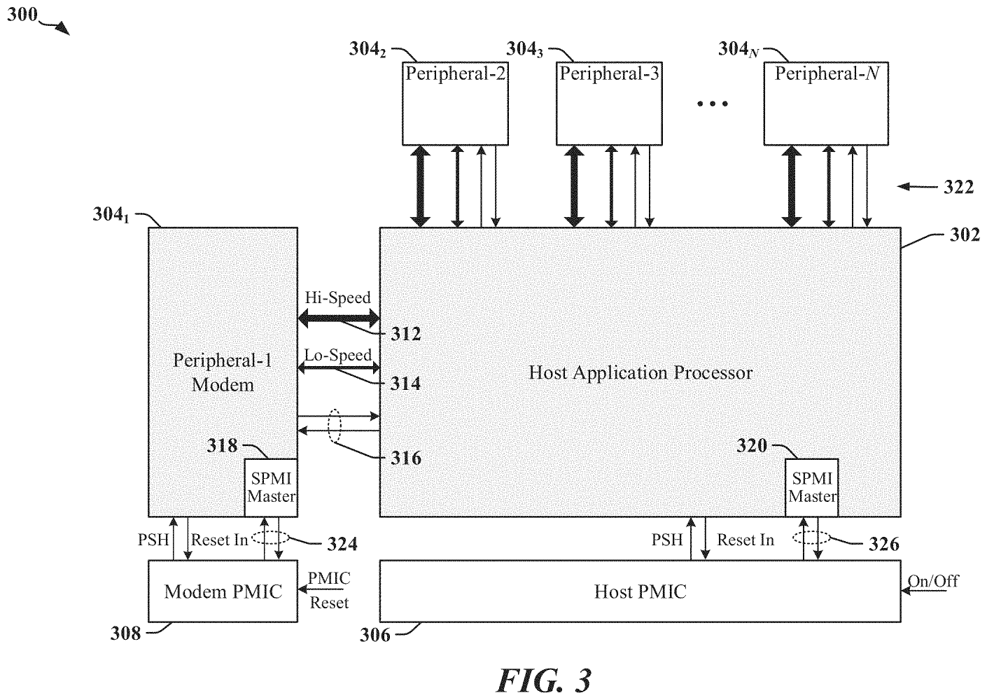

FIG. 3 illustrates an example of a system 300 that employs one or more serial buses 322, 324, 326 that can be operated in accordance with SPMI protocols. The system 300 may include an application processor 302 that can serve as a host device on various communication links, multiple peripherals 304₁-304_{N}, and one or more power management integrated circuits (PMICs 306, 308). In the illustrated system 300, at least a first peripheral 304₁ may include a modem. The application processor 302 and the first peripheral 304₁ may be coupled to respective PMICs 306, 308 using GPIO that provides a combination of reset and other signals, and one or more bus interfaces (SPMI bus masters 318, 320) that couple the application processor 302 and the first peripheral 304₁ to respective PMICs 306, 308. The SPMI bus masters 318, 320 operate respective serial buses 324, 326 according to SPMI protocols defined by the MIPI Alliance. The protocols are optimized for the real-time control of devices including PMICs 306, 308. As SPMI bus may be configured to operate as a shared bus that provides high-speed, low-latency connection for devices, where data transmissions may be managed according to priorities assigned to different traffic classes.

The application processor 302 may be coupled to each of the peripherals 304₁-304_{N} using multiple communication links 312, 314, 322 and GPIO 316. For example, the application processor 302 may be coupled to the first peripheral 304₁ using a high-speed bus 312, a low-speed bus 314 and input and/or output GPIO 316. In one example, the high-speed bus 312 may be operated in accordance with peripheral component interconnect express (PCIe) specifications. In some examples, one or more of the communication links 312, 314, 322 may be operated according to one or more protocols, including I2C, I3C, SPMI, and/or an RFFE interface.

SPMI protocols may be used to implement a general-purpose communication link In various examples, SPMI protocols may be used to provide a power management control bus that can communicate commands to cause circuits and/or functional components to reset, sleep, shutdown, wakeup, and so on. A two-wire serial bus 324, 326 may be used to interconnect some combination of the application processor 302 and one or more peripherals 304₁-304_{N} and/or one or more PMICs 306, 308. In one implementation, between one and four master devices may be coupled to the serial bus and up to 16 slave devices may be supported.

A serial bus may include a first wire (SCLK) that carries a clock signal and a second wire that carries a data signal (SDATA). SPMI protocols support bus contention arbitration, request arbitration and group addressing (to permit peripherals 304₁-304_{N}, and/or PMICs 306, 308 to be written concurrently or simultaneously by a master device (e.g., the application processor 302). In some implementations, SPMI supports a low speed mode that operates with a clock frequency of between 32 kHz and 15 MHz, and a high-speed mode that operates with a clock frequency of between 32 kHz and 26 MHz. SPMI devices may be required to acknowledge certain commands

### Virtual General-Purpose Input/Output

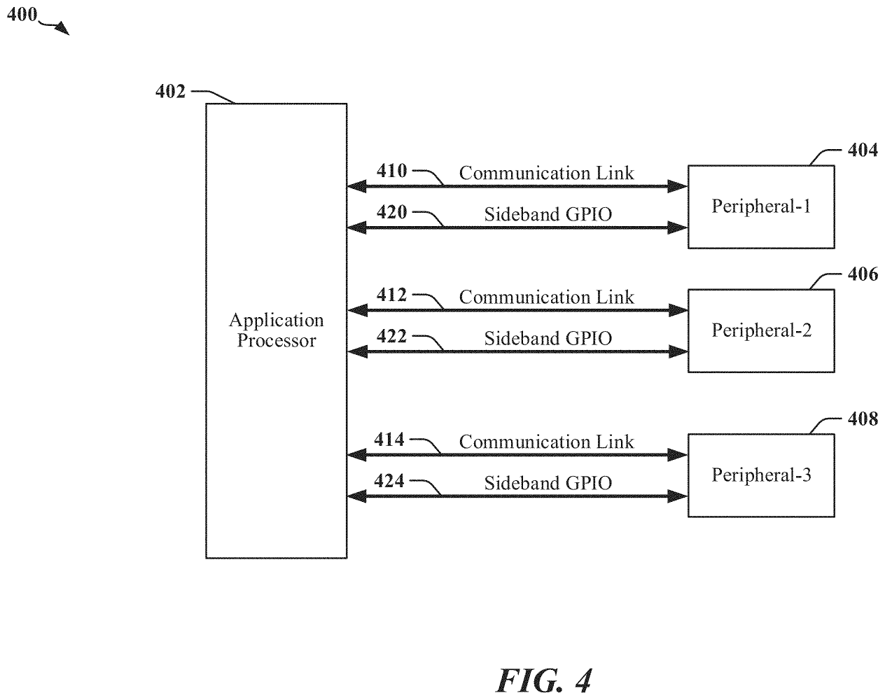

Mobile communication devices, and other devices that are related or connected to mobile communication devices, increasingly provide greater capabilities, performance and functionalities. In many instances, a mobile communication device incorporates multiple IC devices that are connected using a variety of communications links FIG. 4 illustrates an apparatus 400 that includes an Application Processor 402 and multiple peripheral devices 404, 406, 408. In the example, each peripheral device 404, 406, 408 communicates with the Application Processor 402 over a respective communication link 410, 412, 414, which may be operated in accordance with mutually different protocols. Communication between the Application Processor 402 and each peripheral device 404, 406, 408 may involve additional wires that carry control or command signals between the Application Processor 402 and the peripheral devices 404, 406, 408. These additional wires may be referred to as sideband general purpose input/output (sideband GPIO 420, 422, 424), and in some instances the number of connections needed for sideband GPIO 420, 422, 424 can exceed the number of connections used for a communication link 410, 412, 414.

GPIO provides generic pins/connections that may be customized for particular applications. For example, a GPIO pin may be programmable to function as an output, input pin or a bidirectional pin, in accordance with application needs. In one example, the Application Processor 402 may assign and/or configure a number of GPIO pins to conduct handshake signaling or inter-processor communication (IPC) with a peripheral device 404, 406, 408 such as a modem. When handshake signaling is used, sideband signaling may be symmetric, where signaling is transmitted and received by the Application Processor 402 and a peripheral device 404, 406, 408. With increased device complexity, the increased number of GPIO pins used for IPC communication may significantly increase manufacturing cost and limit GPIO availability for other system-level peripheral interfaces.

According to certain aspects of this disclosure, the state of GPIO, including GPIO associated with a communication link, may be captured, serialized and transmitted over a data communication link. In one example, captured GPIO may be transmitted in packets over a serial bus operated in accordance with an I2C, I3C, SPMI, RFFE and/or another protocol. In the example of a serial bus operated in accordance with I3C protocols, common command codes may be used to indicate packet payload and/or destination.

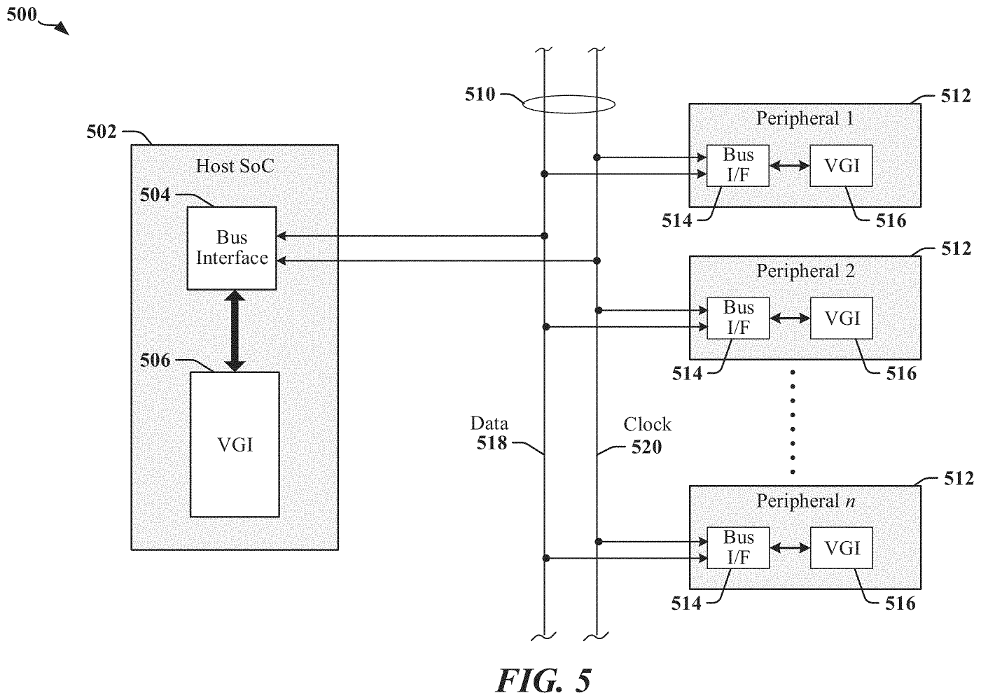

FIG. 5 illustrates an example of an apparatus 500 that uses a multi-wire serial bus 510 to couple various devices including a host SoC 502 and a number of peripheral devices 512. The host SoC 502 may include a virtual GPIO finite state machine (VGI FSM 506) and a bus interface 504, where the bus interface 504 cooperates with corresponding bus interfaces 514 in the peripheral devices 512 to provide a communication link between the host SoC 502 and the peripheral devices 512. Each peripheral device 512 includes a VGI FSM 516. In one example, communications between the host SoC 502 and a peripheral device 512 may be serialized and transmitted over a multi-wire serial bus 510 in accordance with an I3C protocol. The host SoC 502 may include one or more bus interfaces, including I2C, I3C, SPMI and/or RFFE bus interfaces. In some examples, the host SoC 502 may include a configurable interface that may be employed to communicate using I2C, I3C, SPMI, RFFE and/or another suitable protocol. In some examples, a multi-wire serial bus 510 may transmit data in a data signal over a data wire 518 and timing information in a clock signal over a clock wire 520.

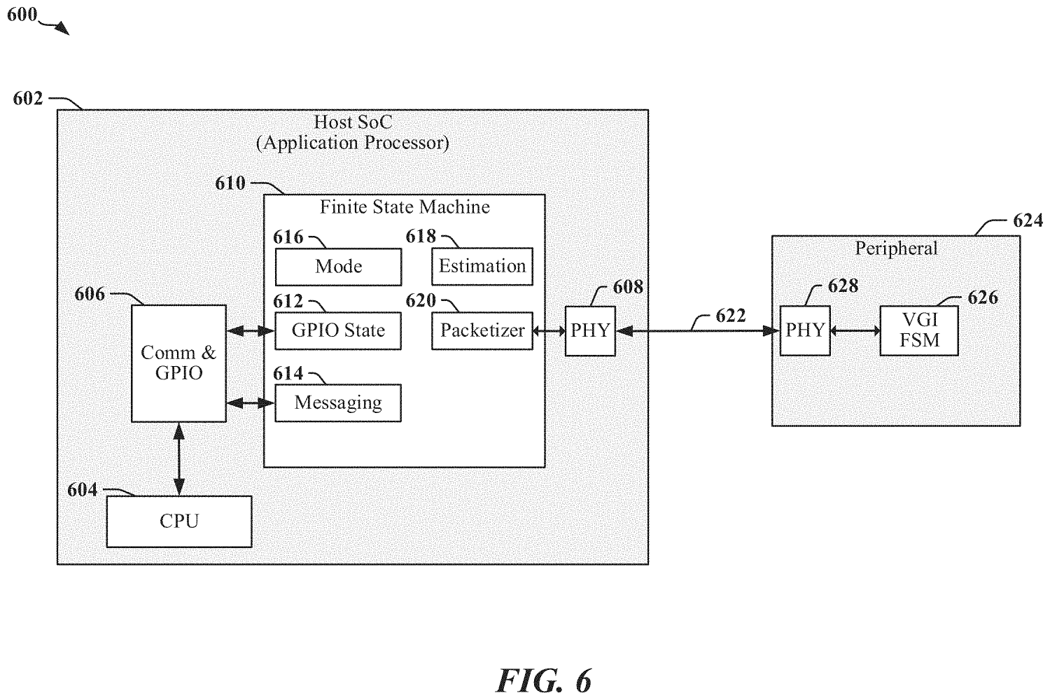

FIG. 6 illustrates an apparatus 600 that is adapted to support Virtual GPIO (VGI or VGMI) in accordance with certain aspects disclosed herein. VGI circuits and techniques can reduce the number of physical pins and connections used to connect an Application Processor 602 with a peripheral device 624, where the Application Processor 602 may be provided in an SoC for example. VGI enables a plurality of GPIO signals to be serialized into virtual GPIO state that can be transmitted over a communication link 622. In one example, virtual GPIO state may be encoded in packets that are transmitted over a communication link 622 that includes a multi-wire bus, including a serial bus. When the communication link 622 is provided as serial bus, the receiving peripheral device 624 may deserialize received packets and may extract messages and virtual GPIO state. A VGI FSM 626 in the peripheral device 624 may convert received virtual GPIO state to physical GPIO signals that can be presented at an internal GPIO interface.

In another example, the communication link 622 may be a provided by a radio frequency transceiver that supports RF communication using, for example, a Bluetooth protocol, a WLAN protocol, a cellular wide area network, and/or another RF communication protocol. When the communication link 622 includes an RF connection, messages and virtual GPIO signals may be encoded in packets, frames, subframes, or other structures that can be transmitted over the communication link 622, and the receiving peripheral device 624 may extract, deserialize and otherwise process received signaling to obtain the messages and virtual GPIO state. Upon receipt of messages and/or virtual GPIO state, the VGI FSM 626 or another component of the receiving device may interrupt its host processor to indicate receipt of messages and/or any changes in physical GPIO signals.

In an example in which the communication link 622 is provided as a serial bus, messages and/or virtual GPIO state may be transmitted in packets configured for an I2C, I3C, SPMI, RFFE or another standardized serial interface. In the illustrated example, VGI techniques are employed to accommodate I/O bridging between an Application Processor 602 and a peripheral device 624. The Application Processor 602 may be implemented as an ASIC, SoC or some combination of devices. The Application Processor 602 includes a processor (central processing unit or CPU 604) that generates messages and GPIO associated with one or more communications channels 606. GPIO signals, events and/or other messages produced by the communications channels 606 may be monitored by respective monitoring circuits 612, 614 in a VGI FSM 626. In some examples, a GPIO monitoring circuit 612 may be adapted to produce virtual GPIO state representative of the state of physical GPIO signals and/or changes in the state of the physical GPIO signals. In some examples, other circuits are provided to produce the virtual GPIO state representative of the state of physical GPIO signals and/or changes in the state of the physical GPIO signals.

An estimation circuit 618 may be configured to estimate latency information for the GPIO signals and messages, and may select a protocol, and/or a mode of communication for the communication link 622 that optimizes the latency for encoding and transmitting the GPIO signals and messages. The estimation circuit 618 may maintain protocol and mode information 616 that characterizes certain aspects of the communication link 622 to be considered when selecting the protocol, and/or a mode of communication. The estimation circuit 618 may be further configured to select a packet type for encoding and transmitting the GPIO signals and messages as virtual GPIO state. The estimation circuit 618 may provide configuration information used by a packetizer 620 to encode the GPIO signals and messages as virtual GPIO state. In one example, the configuration information is provided as a command that may be encapsulated in a packet such that the type of packet and/or a type of payload data (e.g., VGI state) can be determined at a receiver. The configuration information may also be provided to physical layer circuits (PHY 608). The PHY 608 may use the configuration information to select a protocol and/or mode of communication for transmitting the associated packet. The PHY 608 may then generate the appropriate signaling to transmit the packet.

The peripheral device 624 may include a VGI FSM 626 that may be configured to process data packets received from the communication link 622. The VGI FSM 626 at the peripheral device 624 may extract messages and may map bit positions in virtual GPIO state onto physical GPIO pins in the peripheral device 624. In certain embodiments, the communication link 622 is bidirectional, and both the Application Processor 602 and a peripheral device 624 may operate as both transmitter and receiver.

The PHY 608 in the Application Processor 602 and a corresponding PHY 628 in the peripheral device 624 may be configured to establish and operate the communication link 622. The PHY 608 and 628 may be coupled to, or include an RF transceiver 108 (see FIG. 1) that supports RF communications. In some examples, the PHY 608 and 628 may support a two-wire interface such an interface based on I2C, I3C, RFFE, SPMI or another type of interface in the Application Processor 602 and in the peripheral device 624. Virtual GPIO state and messages may be encapsulated into a packet transmitted over the communication link 622, which may be a multi-wire serial bus or multi-wire parallel bus for example.

VGI tunneling, as disclosed herein, can be implemented using existing or available protocols configured for operating the communication link 622, and without the full complement of physical GPIO pins. VGI FSMs 610, 626 may handle GPIO signaling without intervention of a processor in the Application Processor 602 and/or in the peripheral device 624. The use of VGI can reduce pin count, power consumption, and latency associated with the communication link 622.

At the receiving device virtual GPIO state can be converted into physical GPIO signals.

Certain characteristics of the physical GPIO pins may be configured using the virtual GPIO state or messages. For example, slew rate, polarity, drive strength, and other related parameters and attributes of the physical GPIO pins may be configured using the virtual GPIO state or messages. Configuration parameters used to configure the physical GPIO pins may be stored in configuration registers associated with corresponding GPIO pins. These configuration parameters can be addressed using a proprietary or conventional protocol such as I2C, I3C, SPMI or RFFE. In one example, configuration parameters may be maintained in addressable registers. Certain aspects disclosed herein relate to reducing latencies associated with the transmission of configuration parameters and corresponding addresses (e.g., addresses of registers used to store configuration parameters).

The VGI interface disclosed herein enables transmission of virtual GPIO state and other messages, whereby virtual GPIO state, messages, or both can be sent in the serial data stream over a communication link 622. In one example, a serial data stream may be transmitted in packets and/or as a sequence of transactions over a serial bus operated in accordance with an I2C, I3C, SPMI or RFFE protocol. The presence of virtual GPIO data in frame transmitted over the serial bus may be signaled using a special command code to identify the frame as a VGI frame. VGI frames may be transmitted as broadcast frames or addressed frames. In some implementations, a serial data stream may be transmitted in a form that resembles a universal asynchronous receiver/transmitter (UART) signaling protocol, in what may be referred to as VGI_UART mode of operation.

### Configurable Data Lanes

The virtualization of GPIO for transmission over a serial bus can lessen chip manufacturing and materials costs, including costs associated with printed circuit board manufacture. As device complexity increases, demand for increased GPIO can be expected. Increased GPIO demands may be met through virtualization and the use of serial buses. In many systems, SPMI protocols are used to operate serial buses that are available or suitable for handling VGMI traffic. Increased demand on such serial buses may be met when the SPMI interface is adapted in accordance with certain aspects disclose herein. Certain examples presented herein relate to an implementation using SPMI protocols. Certain aspects and concepts disclosed herein are applicable to serial buses operated in accordance with other bus protocols, including I3C and RFFE protocols.

In some implementations, the SPMI interface may be adapted to provide increased low-latency bandwidth without increasing bus operating frequency and/or maintain the bus operating frequency within specified limits. Conventional SPMI protocols support a maximum bus frequency of 26 MHz and can provide a maximum burst throughput of 26 Mbps. The maximum bus frequency may be limited by electrical and timing characteristics of the serial bus. Throughput using SPMI protocols may also be limited by frame and arbitration overhead, which can amount to 50% or more of transactions. The combination of bus frequency limitations and protocol overhead can cause degradation of bus latency as bus traffic increases and/or the number of devices coupled to the bus increases.

Certain aspects of disclosed herein provide a VGI interface that can support communication over multiple data lanes of a serial bus operated in accordance with an SPMI protocol. The multiple data lanes may be allocated in a manner that provides low latency communication of virtualized GPIO state, as well as conventional low-speed and/or mid-speed messaging between applications. The resultant multi-lane SPMI interface can support multiple SPMI data lanes controlled by a common clock signal that can ensure synchronization. The multi-lane SPMI interface can increase overall bandwidth and throughput, while reducing bus latency on data lanes carrying VGI messages, and without increasing the frequency of the clock signal or exceeding the maximum frequency defined by SPMI protocols.

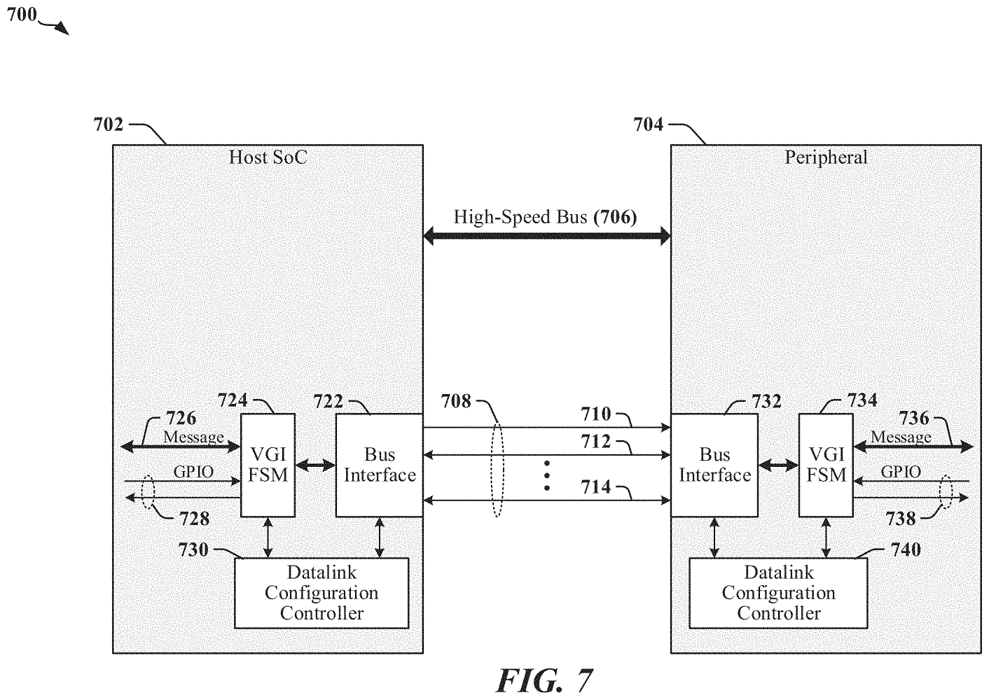

FIG. 7 illustrates certain aspects of a multi-lane interface in a system 700 implemented in accordance with certain aspects disclosed herein. The system 700 includes a host device 702 and peripheral device 704 coupled by a serial datalink 708 configured to communicate some combination of messages 726, 736 and VGI state, where the VGI state represents the signaling state of physical GPIO 728, 738. The host device 702 and peripheral device 704 may be coupled by a high-speed bus 706 that can be used to transfer, low-latency, high-speed and/or high-volume data. In one example, the high-speed bus 706 may be used to transfer image data between the host device 702 and the peripheral device 704.

The host device 702 may be coupled to the serial datalink 708 through a bus interface circuit 722. The bus interface circuit 722 may include physical layer circuits and a controller configured to implement one or more protocols. The physical layer circuits may include line drivers, buffers and timing logic, for example. The host device 702 may include a VGI finite state machine (VGI FSM 724) that can convert the signaling state of physical GPIO 728 to VGI state. In one example, the signaling state of physical GPIO 728 may include the state of sideband signals associated with the high-speed bus 706. The VGI FSM 724 may prioritize transmission of the VGI state and other messages 726 directed to the peripheral device 704.

The peripheral device 704 may be coupled to the serial datalink 708 through a bus interface circuit 732. The bus interface circuit 732 may include physical layer circuits and a controller configured to implement one or more protocols. The physical layer circuits may include line drivers, buffers and timing logic, for example. The peripheral device 704 may include a VGI finite state machine (VGI FSM 734) that can convert signaling state of physical GPIO 738 to VGI state. In one example, the signaling state of physical GPIO 738 may include state of sideband signals associated with the high-speed bus 706. The VGI FSM 734 may prioritize transmission of the VGI state and other messages 736 directed to the peripheral device 704.

The serial datalink 708 may include multiple data lanes, including the data lanes 710, 712 shown in the illustrated system 700. A clock lane 714 carries a clock signal that permits data to be transferred synchronously between the devices 702, 704. In one example, the bus interface circuits 722, 732 include transceivers or other bidirectional line drivers/receivers 214a, 214b and 244a, 244b (see FIG. 2) coupled to each of the data lanes 710, 712.

The deployment of improved technologies, including the 5G new radio technologies defined by the 3rd Generation Partnership Project (3GPP) and the development of Internet of Things (IoT) applications, continually increase the demand for higher data throughput per data lane 710, 712 for communicating VGI state and messaging over the serial datalink 708. In conventional systems, it is typically necessary to increase the frequency of the synchronous clock signal to meet the demand for increased bandwidth. Maximum throughput per data lane 710, 712 may be encountered when clock rates reach a maximum frequency limit that is imposed on the clock signal to avoid signal integrity issues in the unterminated serial datalink 708, for example.

According to certain aspects disclosed herein, the allocation of data lanes 710, 712 may be configured during manufacture, assembly initialization and/or dynamically through the operation of datalink configuration controllers 730, 740 to provide low-latency and/or bandwidth as needed. In some instances, the data lanes 710, 712 may be reconfigured during periods of increased demand uplink and/or downlink data flow according to application needs, and/or based on changing operating conditions.

In some implementations, datalink configuration may be managed by a controller within the bus interface circuits 722, 732, or a processor associated with the bus interface circuits 722, 732. In some implementations, datalink configuration may be managed by the VGI FSMs 724, 734. In some implementations a datalink configuration controller 730, 740 may be provided in the host device 702 and the peripheral device 704, respectively. In one example, the datalink configuration controller 730, 740 may be implemented as a function or component of a processor, controller or state machine, including the VGI FSMs 724, 734. The datalink configuration controllers 730, 740 may communicate through one or more lanes of the serial datalink 708, or through in-band or out-of-band signaling. In some instances, a first datalink configuration controller 730, 740 may determine that an increase or burst of high-priority is occurring or expected. In some instances, a first datalink configuration controller 730, 740 may determine that a low-latency and/or high-priority message is available for transmission. The first datalink configuration controller 730, 740 may send a request to the second datalink configuration controller 740, 730, where the request identifies a change in datalink configuration. In some instances, a single datalink configuration controller 730 or 740 may be implemented to control the configuration of the serial datalink 708.

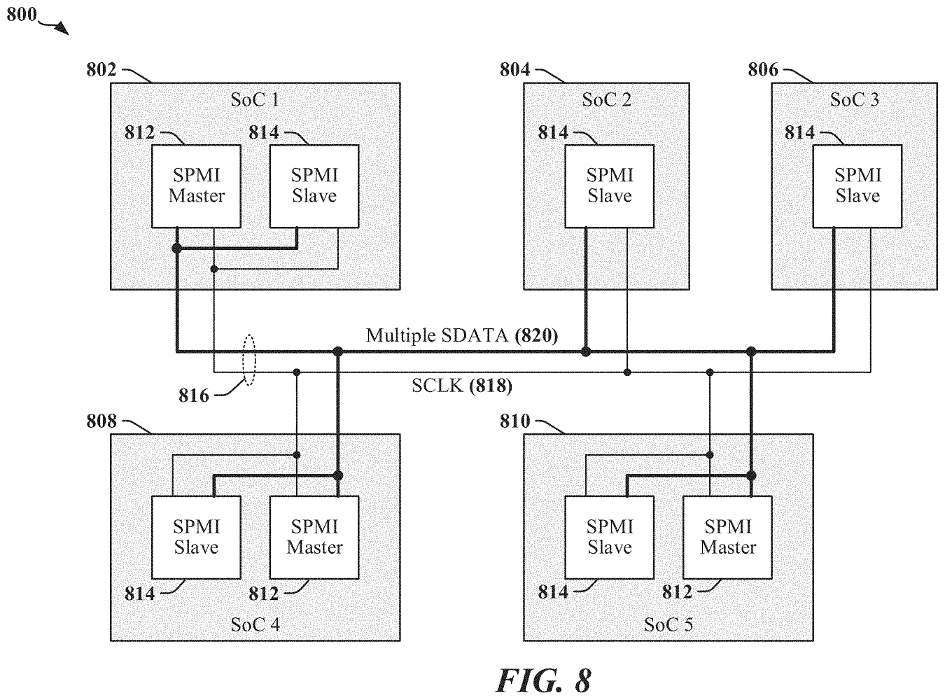

FIG. 8 illustrates certain aspects of a multi-lane SPMI bus implemented in a system 800 in accordance with certain aspects disclosed herein. The system 800 includes multiple SoCs 802, 804, 806, 808, 810 coupled to a multi-lane serial bus 816. The multi-lane serial bus 816 may be operated in accordance with an SPMI protocol, and may include multiple data lanes 820 and a single clock lane 818. SPMI protocols can support multiple bus masters, and each SoC 802, 804, 806, 808, 810 includes at least one bus interface that operates as an SPMI bus master 812 or SPMI slave 814. In the illustrated example, the SoCs 802, 808, 810 include an SPMI bus master 812 and an SPMI slave 814.

The multi-lane serial bus 816 may be operated in accordance with a multi-lane SPMI protocol that can increase bandwidth, improve throughput, and reduce latency in SPMI transactions conducted over the multi-lane serial bus 816. The multi-lane SPMI protocol may support conventional SPMI bus arbitration used on a single-lane SPMI bus. According to certain aspects disclosed herein, the number of additional data lanes 820 activated or used may be scaled to support application requirements.

In some implementations, SPMI transactions may be conducted simultaneously between different pairs of bus masters and bus slaves using different data lanes 820. It will be appreciated that the implementation of a multi-lane bus interface can increase bandwidth, improve throughput, and reduce latency for conventional register data access in power management applications and other applications that use the bus interface.

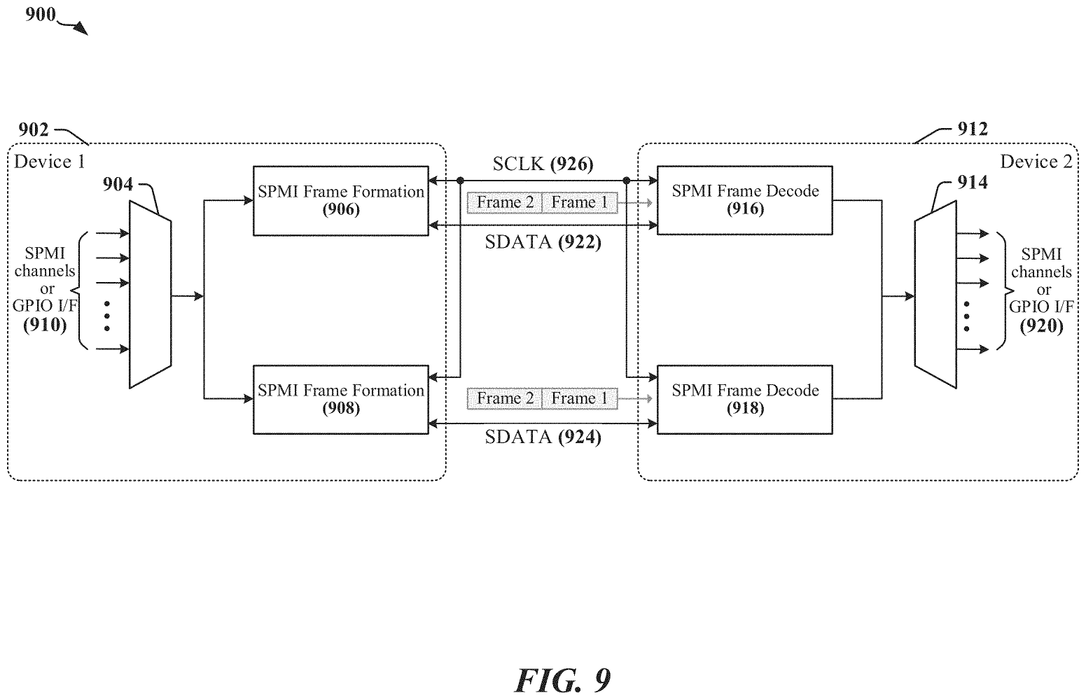

FIG. 9 illustrates a first example of data flow through a multi-lane interface 900 that is operated in accordance with certain aspects disclosed herein. The multi-lane interface 900 may support communications between two or more devices, including the two devices 902, 912 illustrated in FIG. 9. The two devices 902, 912 may be implemented in one or more SoCs, ASICs or other devices. A clock lane 926 carries a clock signal that controls timing of data transfers over a multi-lane serial bus. In FIG. 9, the two data lanes 922, 924 provide a pair of channels between the two devices 902, 912. A multiplexer 904 in the transmitting device 902 can be configured to allocate power management data, application data and/or VGI state information received from multiple sources 910 between the two data lanes 922, 924. Elements or units of application data and/or VGI state information are directed to a frame encoder 906 or 908 corresponding to the allocated data lane 922, 924. The frame encoder 906 or 908 encapsulates power management data, application data and/or VGI state information into SPMI messages addressed to a decoding circuit of the receiving device 912. The frame encoders 906, 908 may be configured to interleave the power management data, application data and/or VGI state information in one or more frames transmitted over the two data lanes 922, 924.

A demultiplexer 914 in the receiving device 912 can be configured to redirect power management data, application data and/or VGI state information extracted from SPMI messages to one or more consumers 920 of the power management data, application data and/or VGI state information. The power management data, application data and/or VGI state information is extracted from the SPMI messages by one of two frame decoders 916, 918. Each frame decoder 916, 918 receives SPMI messages from a corresponding data lane 922, 924.

In one example, the multiplexer 904 and demultiplexer 914 may be configured to allocate a data lane 922, 924 for communicating application or VGI messages between a source and destination pair over one of the data lanes 922, 924. In another example, the multiplexer 904 and demultiplexer 914 may be configured to allocate a data lane 922, 924 for communicating a particular type of message (e.g., application message or VGI message) between the two devices 902, 912. In another example, the frame encoders 906, 908 and frame decoders 916, 918 may be configured to generate and/or format frames to optimize bus latency for high-priority messages, including VGI messages.

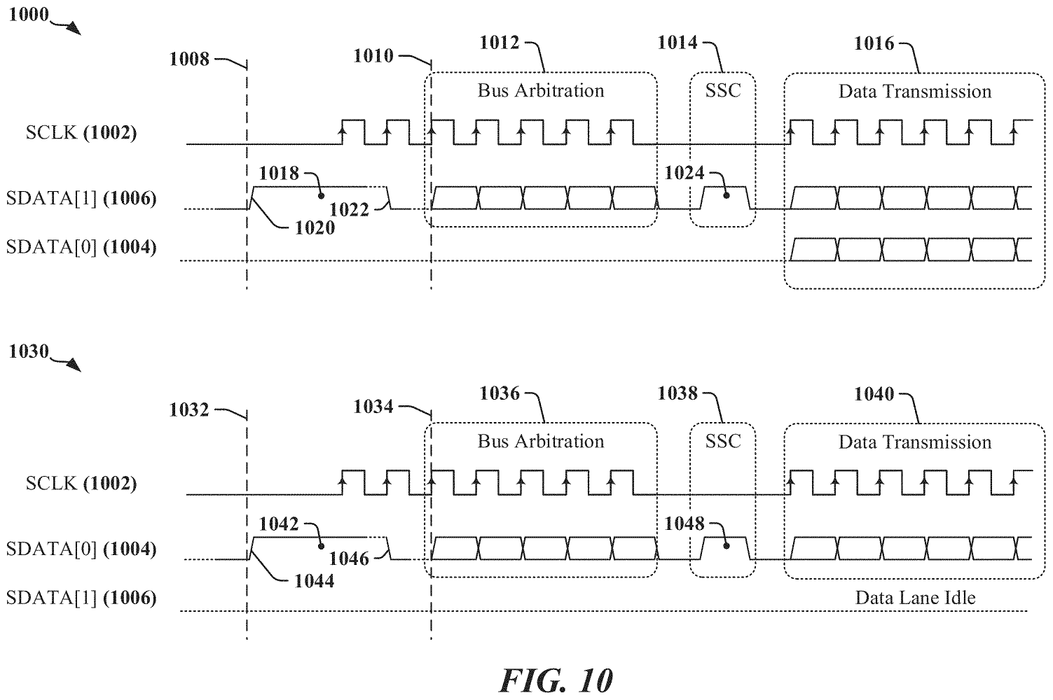

FIG. 10 illustrates certain aspects related to the timing of two SPMI transactions 1000, 1030 executed through the multi-lane interface 900 and between the two devices 902, 912 illustrated in FIG. 9. The first SPMI transaction 1000 involves a multi-lane transmission, while the second SPMI transaction 1030 is executed as a single-lane transmission. In both examples, the transmitting device 902 may be the initiator of the transaction 1000, 1030, and may signal the number of data lanes to be used. The number of data lanes to be used is signaled during bus arbitration, when one or more devices vie for control of the serial bus, and/or while initiating data transmission over the serial bus.

In the first transaction 1000 the initiator device may initiate a bus arbitration procedure 1012 to obtain multi-lane service by actively initiating a first pulse 1018 on a line other than the primary data lane 1004. In the two-lane example illustrated in FIG. 9, the initiating device commences driving the secondary data lane 1006 at a first time 1008 such that a transition (rising edge 1020) is produced on the secondary data lane 1006 to initiate a bus arbitration procedure 1012. Consistent with SPMI protocols, the current bus master provides a clock signal after detecting the rising edge 1020, and the initiating device releases the secondary data lane 1006 during the first clock cycle. The bus master then drives the secondary data lane 1006 to provide the falling edge 1022 of the first pulse 1018, and the bus arbitration procedure 1012 commences at a second time 1010 when devices contending for access to the serial bus drive their respective addresses on the secondary data lane 1006. The winning device, here the transmitting device 902, may then provide a Sequence Start Condition (the SSC 1014) by transmitting a second pulse 1024 on the secondary data lane 1006 while the clock signal in the clock lane 1002 is held in a low signaling state. Each data lane of the multi-lane interface 900 is enumerated, and transmission of the second pulse 1024 on the secondary data lane 1006 indicates that the secondary data lane 1006 is the highest enumerated data lane to be used during the transaction. Payload data 1016 may be transmitted on both the primary data lane 1004 and the secondary data lane 1006.

In the second transaction 1030 the initiator device may initiate a bus arbitration procedure 1012 to obtain single-lane service by actively initiating a first pulse 1042 on the primary data lane 1004. In the two-lane example illustrated in FIG. 9, the initiating device commences driving the primary data lane 1004 at a first time 1032 such that a transition (rising edge 1044) is produced on the primary data lane 1004 to initiate a bus arbitration procedure 1036. In accordance with SPMI protocols, the current bus master provides a clock signal after detecting the rising edge 1044, and the initiating device releases the primary data lane 1004 during the first clock cycle. The bus master then drives the primary data lane 1004 to provide the falling edge 1046 of the first pulse 1042, and the bus arbitration procedure 1036 commences at a second time 1034 when devices contending for access to the serial bus drive their respective addresses on the primary data lane 1004. The winning device, here the transmitting device 902, may then provide the SSC 1038 by transmitting a second pulse 1048 on the primary data lane 1004 while the clock signal in the clock lane 1002 is held in the low signaling state. Payload data 1040 may be transmitted on the primary data lane 1004. The secondary data lane 1006 is idle during the second transaction 1030.

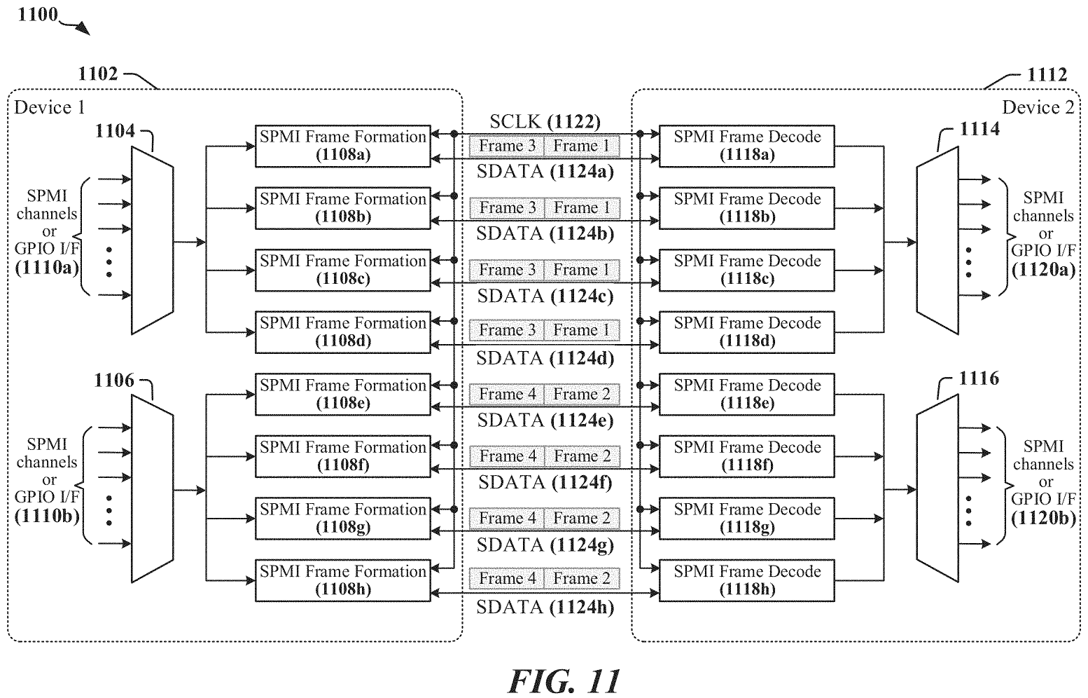

FIG. 11 illustrates a second example of data flow through a multi-lane interface 1100 that is operated in accordance with certain aspects disclosed herein. The multi-lane interface 1100 may support communications between two or more devices, including the two devices 1102, 1112 illustrated in FIG. 11. The two devices 1102, 1112 may be implemented in one or more SoCs, ASICs or other devices. A clock lane 1122 carries a clock signal that controls timing of data transfers over a multi-lane serial bus. In FIG. 11, the 8 data lanes 1124a-1124h are used to provide a pair of 4-lane channels between the two devices 1102, 1112. The transmitting device 1102 in this example has two multiplexers 1104, 1106. Each multiplexer 1104, 1106 is configurable and can allocate power management data, application data and/or VGI state information received from multiple sources 1110a, 1110b to one or more data lanes 1124a-1124d, 1124e-1124h available to the multiplexer 1104, 1106. Elements or units of power management data, application data and/or VGI state information are directed to the frame encoders 1108a-1108h corresponding to the allocated data lanes 1124a-1124h. The frame encoders 1108a-1108h may encapsulate power management data, application data and/or VGI state information into SPMI messages addressed to a decoding circuit of the receiving device 1112. The frame encoders 1108a-1108h may be configured to interleave the power management data, application data and/or VGI state information in one or more frames transmitted over one or more data lanes 1124a-1124h.

Demultiplexers 1114, 1116 in the receiving device 1112 can be configured to redirect power management data, application data and/or VGI state information extracted from SPMI messages to one or more consumers 1120a, 1120b of the power management data, application data and/or VGI state information. The power management data, application data and/or VGI state information is extracted from the SPMI messages by one or more frame decoders 1118a-1118h. Each frame decoder 1118a-1118h operates on SPMI messages carried using a corresponding data lane 1124a-1124h.

In the illustrated example, the multiplexers 1104, 1106 and demultiplexers 1114, 1116 cooperate to provide two multi-lane channels. A first channel is used to carry a first set of frames (Frame 1 and Frame 3), while a second channel is used to carry a second set of frames (Frame 2 and Frame 4). The first channel includes 4 data lanes 1124a-1124d and the second channel includes the other four data lanes 1124e-1124h. In one example, the multiplexers 1104, 1106 and demultiplexers 1114, 1116 may be configured to allocate data lanes 1124a-1124h for communicating power management, application and/or VGI messages between a source and destination pair. In another example, the multiplexers 1104, 1106 and demultiplexers 1114, 1116 may be configured to allocate data lanes 1124a-1124h for communicating a particular type of message (e.g., power management message, application message or VGI message) between the two devices 1102, 1112. In another example, the frame encoders 1108a-1108h and frame decoders 1118a-1118h may be configured to generate and/or format frames to optimize bus latency for high-priority messages, including VGI messages.

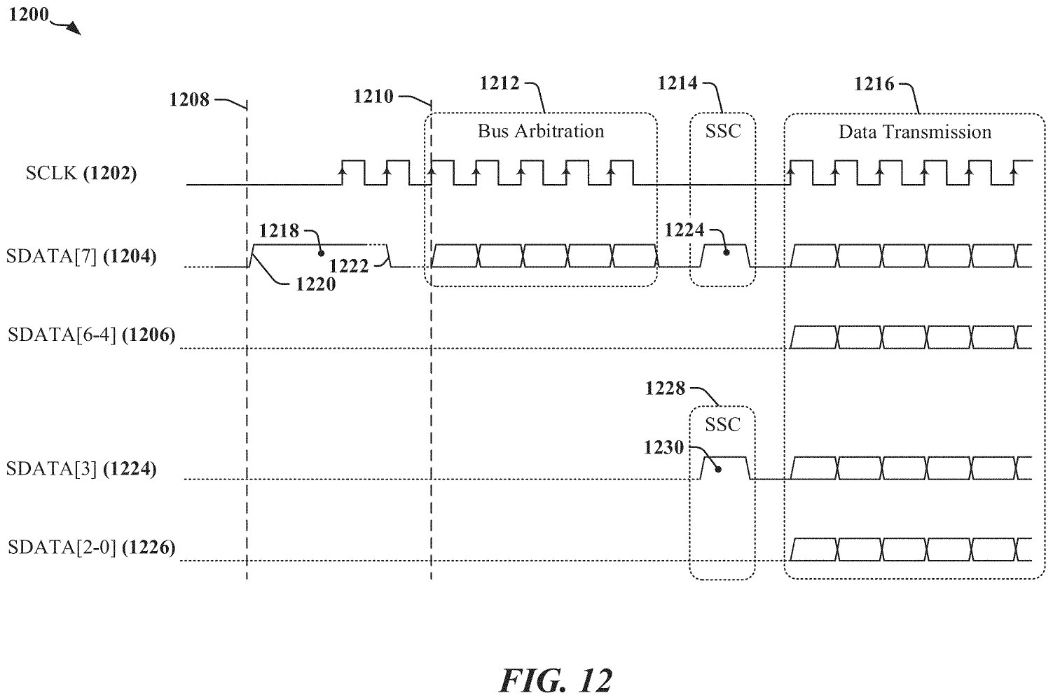

FIG. 12 illustrates certain aspects related to the timing of an SPMI transaction 1200 executed through the multi-lane interface 1100 and between the two devices 1102, 1112 illustrated in FIG. 11. The SPMI transaction 1200 involves multi-lane transmissions on two channels. In the illustrated example, each channel is configured by grouping four of the 8 data lanes 1124a-1124h. The transmitting device 902 may be the initiator of the transaction 1200, and may signal the number of data lanes to be used for the transaction. during bus arbitration. The number of lanes to be used in each channel can be indicated by the transmitting device 902 while initiating data transmission over the serial bus.

In the illustrated transaction 1200 the initiator device may initiate a bus arbitration procedure 1212 to obtain multi-lane service by actively initiating a first pulse 1218 on a lane other than the primary data lane 1124a. In the example illustrated in FIG. 11, the initiating device commences driving SDATA[7] 1204 at a first time 1208 such that a transition (rising edge 1220) is produced on SDATA[7] 1204 to initiate a bus arbitration procedure 1212. SDATA[7] 1204 may correspond to the seventh enumerated data lane 1124h in FIG. 11 and indicates that all 8 data lanes 1124a-1124h are to be used, activated and/or available for the transaction 1200. Consistent with SPMI protocols, the current bus master provides a clock signal after detecting the rising edge 1220, and the initiating device releases SDATA[7] 1204 during the first clock cycle. The bus master then drives SDATA[7] 1204 to provide the falling edge 1222 of the first pulse 1218, and the bus arbitration procedure 1212 commences at a second time 1210 when devices contending for access to the serial bus drive their respective addresses on SDATA[7] 1204.

The transmitting device 1102 may provide an SSC 1214 on SDATA[7] 1204 by transmitting a second pulse 1224 on SDATA[7] 1204 while the clock signal in the clock lane 1202 is held in a low signaling state, and may transmit an SSC 1228 on SDATA[3] 1224 by transmitting a third pulse 1230 on SDATA[3] 1224. The transmission of two SSCs 1214 and 1228 indicates that the 8 data lanes 1124a-1124h are to be divided into two 4-lane channels for the transaction. The lanes on which the SSCs 1214 and 1228 are transmitted indicate the highest enumerated data lane in the channel. In this example, part of the data payload 1216 is transmitted over a first channel including SDATA[7] 1204 and SDATA[6-4] 1206 and the remainder of the payload is transmitted over a second channel including SDATA[3] 1224 and SDATA[2-0] 1226. The first channel corresponds to data lanes 1124e-1124h, and the second channel corresponds to data lanes 1124a-1124d.

It will be appreciated that the available data lanes 1124a-1124h may be divided as desired between any feasible number of channels, including single-lane channels and multi-lane channels. The number of feasible channels may be determined by the number of available data lanes 1124a-1124h and the number of multiplexers 1104, 1106 and demultiplexers 1114, 1116. In one example, a single SSC sent on one of the available data lanes 1124a-1124h indicates that a single frame is to be sent (i.e., one channel) and the location of the last of the data lanes 1124a-1124h to be included in the channel. More-highly enumerated available data lanes 1124a-1124h may be idled when a single channel is selected with fewer than the total number of available data lanes 1124a-1124h.

In certain examples, an SPMI frame can be sent across a multi-lane channel in an interleaved fashion. The transmission of a single frame over multiple data lanes can provide significant improvement in bandwidth and throughput. In some implementations, multiple channels can be configured and an SPMI initiator can send two or more SPMI frames concurrently. Each concurrently-transmitted frame may be transmitted over multiple data lanes, providing improved latency as well as increased bandwidth over conventional systems.

In certain implementations, a different number of frames may be sent on two channels of equal size (number of data lanes), or the same number of frames may be sent on channels that have different sizes. In these implementations, the receiver is configured to continue receiving on one channel after another channel has completed transmission. The receiver may determine differences in channel-specific payload durations from information provided in control signaling associated with the transaction, and/or through configuration information maintained in register space that identifies characteristics of one or more bus configurations.

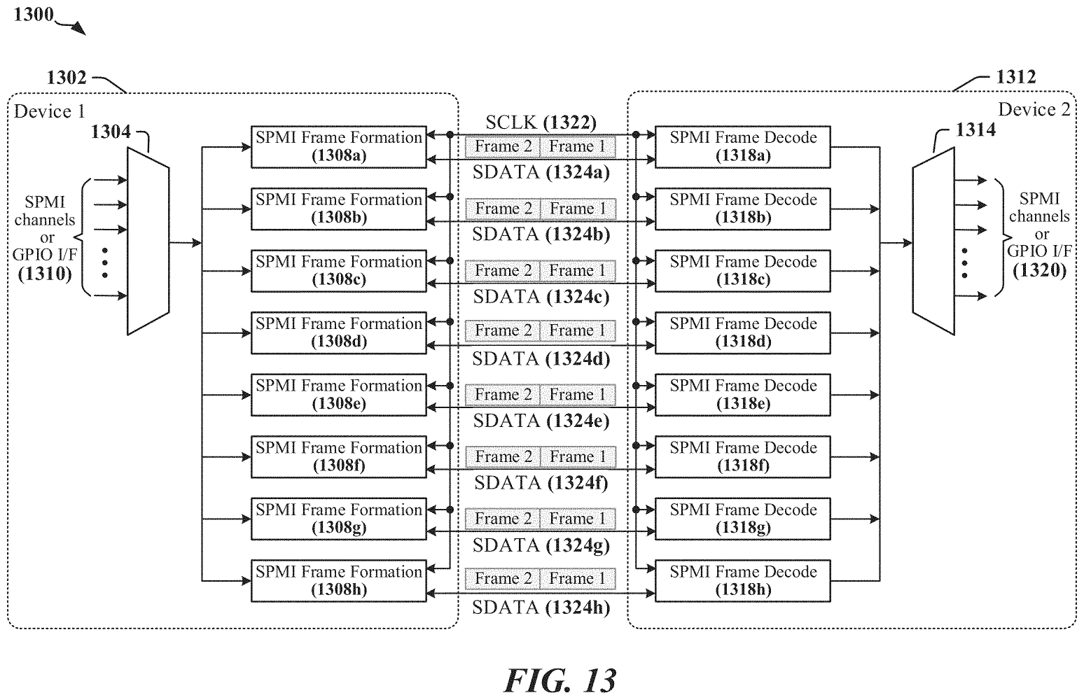

In certain implementations, priority access may be granted when a device requests access to the bus on the first and last data lanes. FIG. 13 illustrates a third example of data flow through a multi-lane interface 1300 that is operated in accordance with certain aspects disclosed herein. The third example relates to a multi-lane interface 1300 that can support prioritized bus access for communication between two or more devices, including the two devices 1302, 1312 illustrated in FIG. 13. The two devices 1302, 1312 may be implemented in one or more SoCs, ASICs or other devices. A clock lane 1322 carries a clock signal that controls timing of data transfers over a multi-lane serial bus. In FIG. 13, the transmitting device 1302 is depicted with a single multiplexer 1304. The transmitting device 1302 may have additional multiplexers, but these are not shown. The multiplexer 1304 may be configured to allocate power management data, application data and/or VGI state information received from multiple sources 1310 to one or more data lanes 1324a-1324h available to the multiplexer 1304. Elements or units of power management data, application data and/or VGI state information may be directed to frame encoders 1308a-1308h corresponding to the allocated data lanes 1324a-1324h. The frame encoders 1308a-1308h may encapsulate power management data, application data and/or VGI state information into SPMI messages addressed to a decoding circuit of the receiving device 1312. In some instances, the frame encoders 1308a-1308h may be configured to interleave the power management data, application data and/or VGI state information in one or more frames transmitted over one or more data lanes 1324a-1324h.

The receiving device 1312 has a demultiplexer 1314 that can be configured to redirect power management data, application data and/or VGI state information extracted from SPMI messages to one or more consumers 1320 of the power management data, application data and/or VGI state information. The receiving device 1312 may have additional demultiplexers, but these are not shown. The power management data, application data and/or VGI state information may be extracted from the SPMI messages by one or more frame decoders 1318a-1318h. Each frame decoder 1318a-1318h operates on SPMI messages carried on a corresponding data lane 1324a-1324h.

In the illustrated example, the multiplexer 1304 and demultiplexer 1314 may use a channel that includes all data lanes 1324a-1324h to carry high-priority messages. The allocation of all data lanes 1324a-1324h to a single channel can maximize throughput and minimize latency in high-priority transactions. In some instances, the multiplexer 1304 and demultiplexer 1314 may be configured to use fewer than all data lanes 1324a-1324h to carry high-priority messages. In one example, the multiplexer 1304 and demultiplexer 1314 may be configured to allocate data lanes 1324a-1324h for communicating power management, application and/or VGI messages between a source and destination pair. In another example, the multiplexer 1304 and demultiplexer 1314 may be configured to allocate data lanes 1324a-1324h for communicating a particular type of message (e.g., power management message, application message or VGI message) between the two devices 1302, 1312. In another example, the frame encoders 1308a-1308h and frame decoders 1318a-1318h may be configured to generate and/or format frames to optimize bus latency for high-priority messages, including VGI messages.

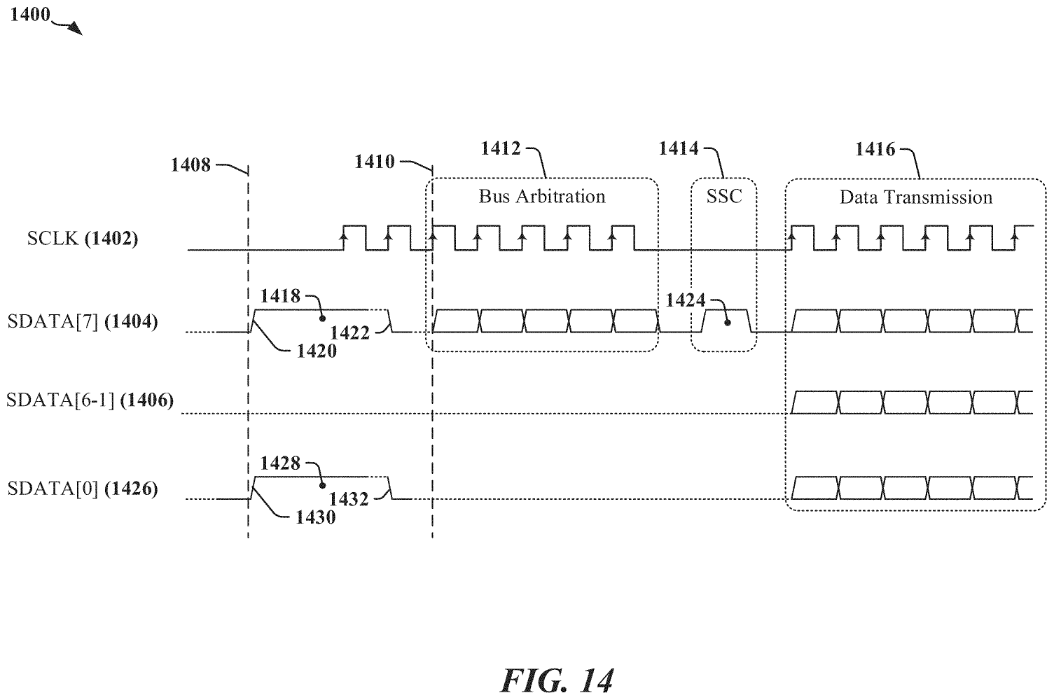

FIG. 14 illustrates certain aspects related to the timing of a high-priority SPMI transaction 1400 executed through the multi-lane interface 1300 and between the two devices 1302, 1312 illustrated in FIG. 13. The high-priority SPMI transaction 1400 may be initiated during bus arbitration. A high priority bus request may be asserted when a bus request is asserted on more than one data lane 1324a-1324h. Typically, a high priority bus request is signaled when a requesting device 1302 drives a first pulse 1418 on the highest enumerated data lane 1324h (SDATA[7] 1404) and drives a concurrent pulse 1428 on the primary data lane 1324a (SDATA[0] 1424). In some instances, a lowest-priority bus request is asserted by driving a single pulse 1428 on the primary data lane 1324a.

In the illustrated transaction 1400 the initiator device may initiate a bus arbitration procedure 1412 to obtain high-priority multi-lane service by actively initiating a first pulse 1418 on SDATA[7] 1404 while initiating a concurrent pulse 1428 on SDATA[0] 1426. The initiating device commences driving SDATA[7] 1404 and SDATA[0] 1426 at a first point in time 1408 such that transitions (rising edges 1420, 1430) are produced on SDATA[7] 1404 and SDATA[0] 1426 to initiate a bus arbitration procedure 1412 with an indication that the bus request is a high-priority request. SDATA[7] 1404 may correspond to the seventh enumerated data lane 1324h in FIG. 13 and the first pulse 1418 further indicates that all 8 data lanes 1324a-1324h are to be used, activated and/or available for the transaction 1400. Consistent with SPMI protocols, the current bus master provides a clock signal after detecting the rising edge 1420, and the initiating device releases SDATA[7] 1404 and SDATA[0] 1426 during the first clock cycle. The bus master then drives SDATA[7] 1404 and SDATA[0] 1426 to provide the falling edge 1422 of the first pulse 1418 and the falling edge 1432 of the second pulse 1428. SDATA[0] 1426 may be idled while the bus arbitration procedure 1412 proceeds on SDATA[7] 1404 at a second time 1410, when devices contending for access to the serial bus drive their respective addresses on SDATA[7] 1404. When a high-priority bus request is asserted, devices concurrently asserting a low-priority request may refrain from participating further in the bus arbitration procedure 1412.

In some implementations, devices wishing to assert a low-priority request when a high-priority bus request is asserted do not refrain from participating in a bus arbitration procedure associated with the next bus request opportunity. In certain instances, deadlocks may be avoided when a device persists in arbitration in the bus arbitration procedure associated with the next bus request opportunity. A deadlock can occur when two devices assert a low-priority request that causes pulses to be concurrently transmitted on two data lanes. In one example, a first slave device may assert a low-priority bus request by transmitting a pulse on SDATA[0] 1426 (the primary data lane), while a second slave device asserts a low-priority bus request by transmitting a pulse on SDATA[7] 1404 (the highest enumerated data lane). The bus master and the two initiating slave devices may incorrectly determine that a high-priority bus request has been asserted, and the bus arbitration procedure 1412 process may fail because both initiating slave devices refrain from participating further in the bus arbitration procedure 1412. Deadlock may be avoided when the bus master and initiating slave devices observe bus activity and recognize the false high-priority request. Recognition of the false high-priority request may be based on whether any device participated in the bus arbitration procedure 1412 and/or transmitted data after winning the bus arbitration procedure 1412. One or more of the initiating slave devices may reassert a low-priority bus request at the next opportunity and may participate in the associated bus arbitration procedure even when concurrent pulses observed on the primary data lane and the highest enumerated data lane indicate assertion of a possible high-priority bus request.

Having won the high-priority bus arbitration procedure 1412, the transmitting device 1302 may provide an SSC 1414 on SDATA[7] 1404 by transmitting a second pulse 1424 on SDATA[7] 1404 while the clock signal in the clock lane 1402 is held in a low signaling state. The transmission of the SSC 1414 indicates that the 8 data lanes 1324a-1324h are to be used for the transaction. The lanes on which the SSC 1414 is transmitted indicates the highest enumerated data lane in the channel. In this example, the data payload 1416 is transmitted over all data lanes 1324a-1324h.

In certain examples, an SPMI frame can be sent across a multi-lane channel in an interleaved fashion. The transmission of a single frame over multiple data lanes can provide significant improvement in bandwidth and throughput. In some implementations, multiple channels can be configured and an SPMI initiator can send two or more SPMI frames concurrently. Each concurrently-transmitted frame may be transmitted over multiple data lanes, providing improved latency as well as increased bandwidth over conventional systems. In one example, the data payload 1416 may be interleaved and transmitted on all data lanes 1324a-1324h. In some instances, the transmitting device 1302 may determine if a single frame can be sent on all data lanes 1324a-1324h or on a portion of the data lanes 1324a-1324h. The number of data lanes 1324a-1324h may be indicated by the data lane 1324a-1324h in which the second pulse 1424 of the SSC 1414 is transmitted. Unused data lanes 1324a-1324h during a data transfer may be used by the transmitting device 1302 to send other messages concurrently with the high-priority data payload 1416. In some instances, the unused data lanes 1324a-1324h may be used for communication with other devices coupled to the multi-lane bus.

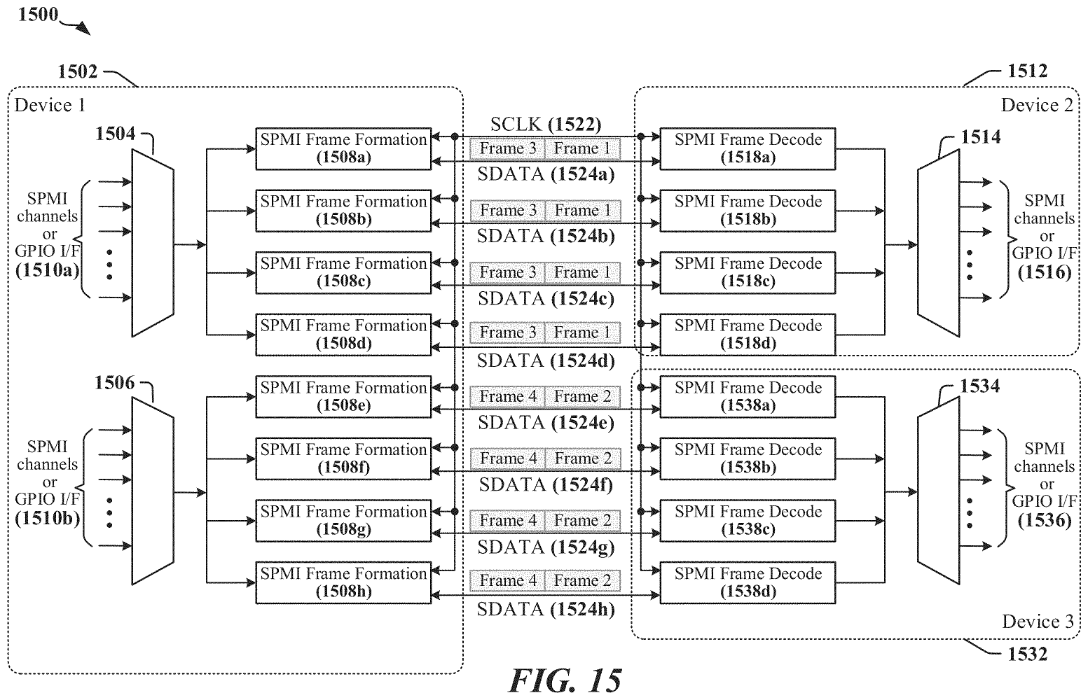

FIG. 15 illustrates a fourth example of data flow through a multi-lane interface 1500 that is operated in accordance with certain aspects disclosed herein. The multi-lane interface 1500 may support concurrent communications between three or more devices, including the devices 1502, 1512, 1532 illustrated in FIG. 15. The devices 1502, 1512, 1532 may be implemented in one or more SoCs, ASICs or other devices. A clock lane 1522 carries a clock signal that controls timing of data transfers over a multi-lane serial bus. In FIG. 15, the 8 data lanes 1524a-1524h are used to provide a pair of 4-lane channels between the transmitting device 1502 and two receiving devices 1512, 1532. The transmitting device 1502 in this example has two multiplexers 1504, 1506. Each multiplexer 1504, 1506 is configurable and can allocate power management data, application data and/or VGI state information received from multiple sources 1510a, 1510b to one or more data lanes 1524a-1524d, 1524e-1524h available to the multiplexer 1504, 1506 in order to direct portions of the power management data, application data and/or VGI state information to the consuming receiving devices 1512, 1532. Elements or units of power management data, application data and/or VGI state information are directed to the frame encoders 1508a-1508h corresponding to the allocated data lanes 1524a-1524h. The frame encoders 1508a-1508h may encapsulate power management data, application data and/or VGI state information into SPMI messages addressed to a decoding circuit of the corresponding receiving device 1512, 1532. The frame encoders 1508a-1508h may be configured to interleave the power management data, application data and/or VGI state information in one or more frames transmitted over one or more data lanes 1524a-1524d, 1524e-1524h in the two channels.

Demultiplexers 1514, 1534 in the receiving devices 1512, 1532 can be configured to redirect power management data, application data and/or VGI state information extracted from SPMI messages to one or more consumers 1516, 1536 of the power management data, application data and/or VGI state information. The power management data, application data and/or VGI state information is extracted from the SPMI messages by one or more frame decoders 1518a-1518d, 1538a-1538d. Each frame decoder 1518a-1518d, 1538a-1538d operates on SPMI messages carried using a corresponding data lane 1524a-1524d or 1524e-1524h.

In the illustrated example, the multiplexers 1504, 1506 and demultiplexers 1514, 1534 cooperate to provide two multi-lane channels. A first channel is used to carry a first set of frames (Frame 1 and Frame 3) to a first receiving device 1512, while a second channel is used to carry a second set of frames (Frame 2 and Frame 4) to a second receiving device 1532. The first channel includes 4 data lanes 1524a-1524d and the second channel includes the other four data lanes 1524e-1524h. In one example, the multiplexers 1504, 1506 and demultiplexers 1514, 1534 may be configured to allocate data lanes 1524a-1524h for communicating power management, application and/or VGI messages between the receiving devices 1512, 1532. In another example, the multiplexers 1504, 1506 and demultiplexers 1514, 1534 may be configured to allocate data lanes 1524a-1524h for communicating a particular type of message (e.g., power management message, application message or VGI message) between the transmitting device 1502 and the receiving devices 1512, 1532. In another example, the frame encoders 1508a-1508h and frame decoders 1518a-1518d, 1538a-1538d may be configured to generate and/or format frames to optimize bus latency for high-priority messages, including VGI messages in each multi-lane channel.

### Examples of Processing Circuits and Methods

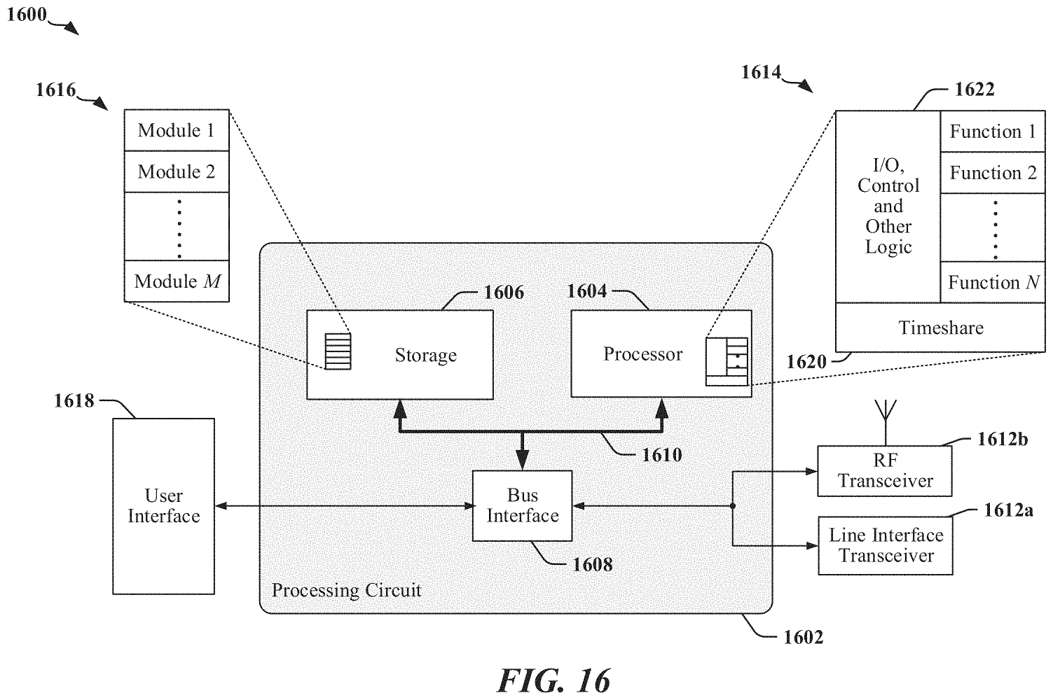

FIG. 16 is a diagram illustrating an example of a hardware implementation for an apparatus 1600 employing a processing circuit 1602. The processing circuit 1602 may include or configure the operation of a finite state machine 610, 626 (see FIG. 6). In some examples, the apparatus 1600 may perform one or more functions disclosed herein. In accordance with various aspects of the disclosure, an element, or any portion of an element, or any combination of elements as disclosed herein may be implemented using a processing circuit 1602. The processing circuit 1602 may include one or more processors 1604 that are controlled by some combination of hardware and software modules. Examples of processors 1604 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1604 may include specialized processors that perform specific functions, and that may be configured, augmented or controlled by one of the software modules 1616. The one or more processors 1604 may be configured through a combination of software modules 1616 loaded during initialization, and further configured by loading or unloading one or more software modules 1616 during operation.

In the illustrated example, the processing circuit 1602 may be implemented with a bus architecture, represented generally by the bus 1610. The bus 1610 may include any number of interconnecting buses and bridges depending on the specific application of the processing circuit 1602 and the overall design constraints. The bus 1610 links together various circuits including the one or more processors 1604, and storage 1606. Storage 1606 may include memory devices and mass storage devices, and may be referred to herein as computer-readable media and/or processor-readable media.

In some examples, the storage 1606 includes registers used to communicate virtual GPIO information. One set of registers may be configured to maintain address, management and payload information corresponding to a physical GPIO and one or more devices to which virtual GPIO information is transmitted. Another set of registers may maintain information in a format corresponding to the one or more devices to which the virtual GPIO information is transmitted.

The bus 1610 may also link various other circuits such as timing sources, timers, peripherals, voltage regulators, and power management circuits. A bus interface 1608 may provide an interface between the bus 1610 and one or more transceivers 1612a, 1612b. A transceiver 1612a, 1612b may be provided for each networking technology supported by the processing circuit. In some instances, multiple networking technologies may share some or all of the circuitry or processing modules found in a transceiver 1612a, 1612b. Each transceiver 1612a, 1612b provides a means for communicating with various other apparatus over a transmission medium. In one example, a transceiver 1612a may be used to couple the apparatus 1600 to a multi-wire bus. In another example, a transceiver 1612b may be used to connect the apparatus 1600 to a radio access network. Depending upon the nature of the apparatus 1600, a user interface 1618 (e.g., keypad, display, speaker, microphone, joystick) may also be provided, and may be communicatively coupled to the bus 1610 directly or through the bus interface 1608.

A processor 1604 may be responsible for managing the bus 1610 and for general processing that may include the execution of software stored in a computer-readable medium that may include the storage 1606. In this respect, the processing circuit 1602, including the processor 1604, may be used to implement any of the methods, functions and techniques disclosed herein. The storage 1606 may be used for storing data that is manipulated by the processor 1604 when executing software, and the software may be configured to implement any one of the methods disclosed herein.

One or more processors 1604 in the processing circuit 1602 may execute software.

Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1606 or in an external computer-readable medium. The external computer-readable medium and/or storage 1606 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1606 may also include, by way of example, a carrier wave, a transmission line, and any other suitable medium for transmitting software and/or instructions that may be accessed and read by a computer. Computer-readable medium and/or the storage 1606 may reside in the processing circuit 1602, in the processor 1604, external to the processing circuit 1602, or be distributed across multiple entities including the processing circuit 1602. The computer-readable medium and/or storage 1606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1606 may maintain software maintained and/or organized in loadable code segments, modules, applications, programs, etc., which may be referred to herein as software modules 1616. Each of the software modules 1616 may include instructions and data that, when installed or loaded on the processing circuit 1602 and executed by the one or more processors 1604, contribute to a run-time image 1614 that controls the operation of the one or more processors 1604. When executed, certain instructions may cause the processing circuit 1602 to perform functions in accordance with certain methods, algorithms and processes described herein.

Some of the software modules 1616 may be loaded during initialization of the processing circuit 1602, and these software modules 1616 may configure the processing circuit 1602 to enable performance of the various functions disclosed herein. For example, some software modules 1616 may configure internal devices and/or logic circuits 1622 of the processor 1604, and may manage access to external devices such as the transceiver 1612a, 1612b, the bus interface 1608, the user interface 1618, timers, mathematical coprocessors, and so on. The software modules 1616 may include a control program and/or an operating system that interacts with interrupt handlers and device drivers, and that controls access to various resources provided by the processing circuit 1602. The resources may include memory, processing time, access to the transceiver 1612a, 1612b, the user interface 1618, and so on.

One or more processors 1604 of the processing circuit 1602 may be multifunctional, whereby some of the software modules 1616 are loaded and configured to perform different functions or different instances of the same function. The one or more processors 1604 may additionally be adapted to manage background tasks initiated in response to inputs from the user interface 1618, the transceiver 1612a, 1612b, and device drivers, for example. To support the performance of multiple functions, the one or more processors 1604 may be configured to provide a multitasking environment, whereby each of a plurality of functions is implemented as a set of tasks serviced by the one or more processors 1604 as needed or desired. In one example, the multitasking environment may be implemented using a timesharing program 1620 that passes control of a processor 1604 between different tasks, whereby each task returns control of the one or more processors 1604 to the timesharing program 1620 upon completion of any outstanding operations and/or in response to an input such as an interrupt. When a task has control of the one or more processors 1604, the processing circuit is effectively specialized for the purposes addressed by the function associated with the controlling task. The timesharing program 1620 may include an operating system, a main loop that transfers control on a round-robin basis, a function that allocates control of the one or more processors 1604 in accordance with a prioritization of the functions, and/or an interrupt driven main loop that responds to external events by providing control of the one or more processors 1604 to a handling function.

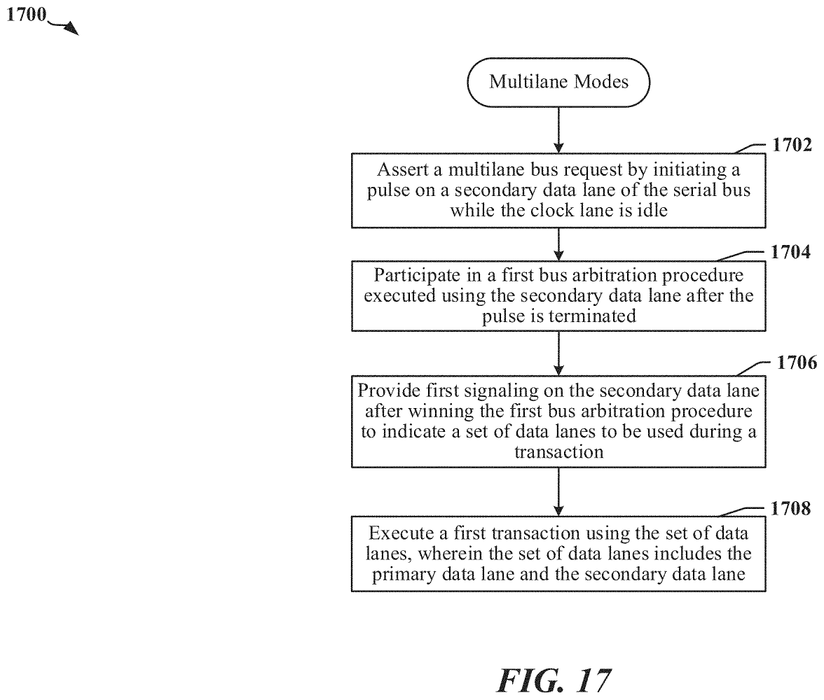

FIG. 17 is a flowchart 1700 of a method that may be performed at a device coupled to a serial bus that has a clock lane, a primary data lane and one or more additional data lanes. In one example the serial bus is operated in accordance with an SPMI protocol. In other examples, the serial bus may be operated in accordance with an I2C, I3C, RFFE or other protocol.

At block 1702, the device may assert a multilane bus request by initiating a pulse on a secondary data lane of the serial bus while the clock lane is idle. At block 1704, the device may participate in a first bus arbitration procedure executed using the secondary data lane after the pulse is terminated. At block 1706, the device may provide first signaling on the secondary data lane after winning the first bus arbitration procedure to indicate a set of data lanes to be used during a transaction. The first signaling may be initial signaling transmitted at the commencement of a transaction. At block 1708, the device may execute a first transaction using the set of data lanes. The set of data lanes may include the primary data lane and the secondary data lane. The set of data lanes may also include at least one additional data lane.

In some instances, the device may assert a single-lane bus request by initiating a pulse on the primary data lane after the first transaction has been completed, participate in a second bus arbitration procedure executed using the primary data lane after the pulse is terminated, and execute a second transaction using the primary data lane.

In certain implementations, the device provides second signaling on at least one additional data lane while providing the first signaling on the secondary data lane. In one example, the first signaling may include a first SSC and the second signaling may include a second SSC. The device may execute the first transaction by transmitting a data payload using two or more channels. Each channel may include one or more data lanes. The device may configure the two or more channels based on an enumeration of the secondary data lane and the at least one additional data lane. For example, the primary data lane may be enumerated as SDATA[0] and the additional lanes may be enumerated as SDATA[1]-SDATA[7]. In one example of channel configuration, a first SSC may be transmitted on SDATA[5] indicating that a first channel includes SDATA[0]-SDATA[5] and a second SSC may be transmitted on SDATA[7] indicating that a second channel includes SDATA[5]-SDATA[7]. The device may interleave one or more frames in the data payload over the one or more data lanes of at least one channel. The device may transmit a first portion of the data payload over a first channel to a first receiving device coupled to the serial bus, and transmit a second portion of the data payload over a second channel to a second receiving device coupled to the serial bus.

In some implementations, the device may initiate a pulse on the primary data lane while initiating the pulse on the secondary data lane. The presence of pulses on the primary data lane and the secondary data lane may be indicative of a high-priority multilane bus request. The set of data lanes may include a maximum number of data lanes available for executing the first transaction in response to the high-priority request. In one example, a serial bus may have 8 available data lanes (SDATA[0]-SDATA[7]). In another example, the serial bus may have more than 8 data lanes, with only 8 coupling the transmitting and receiving devices.

In a first example, the device may transmit VGI state information in the first transaction. In a second example, the device may transmit application data in the first transaction. In a third example, the device may transmit power management information in the first transaction. In various examples, the device transmits some combination of VGI state information, application data, and/or power management information in the first transaction.

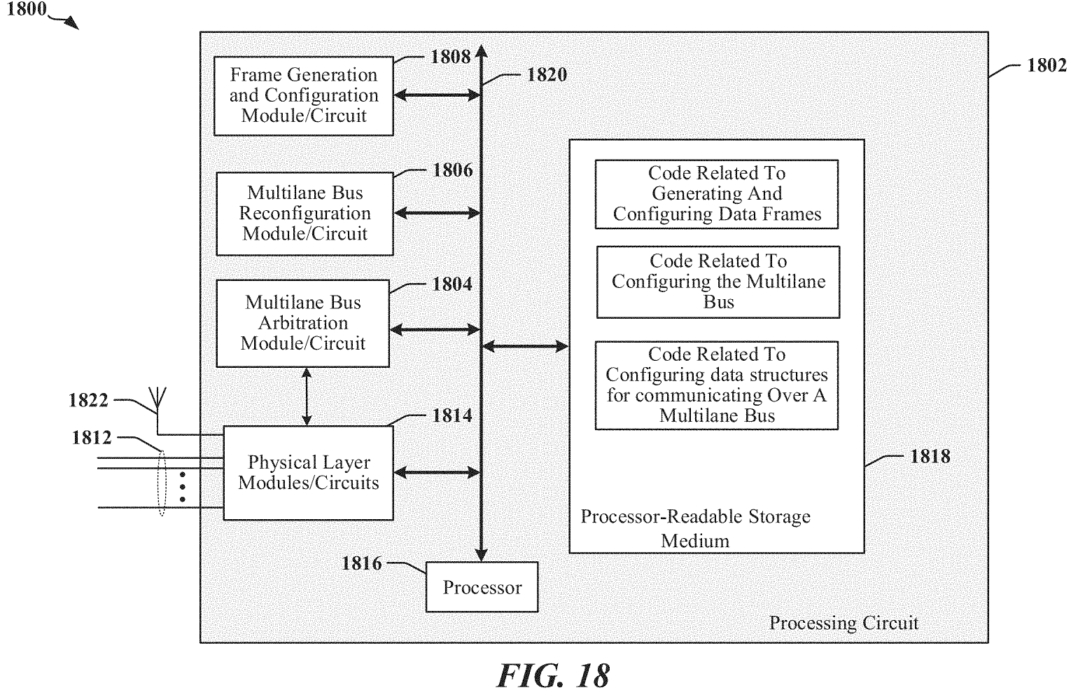

FIG. 18 is a diagram illustrating an example of a hardware implementation for an apparatus 1800 employing a processing circuit 1802. The apparatus may implement a bridging circuit in accordance with certain aspects disclosed herein. The processing circuit typically has a controller or processor 1816 that may include one or more microprocessors, microcontrollers, digital signal processors, sequencers and/or state machines. The processing circuit 1802 may be implemented with a bus architecture, represented generally by the bus 1820. The bus 1820 may include any number of interconnecting buses and bridges depending on the specific application of the processing circuit 1802 and the overall design constraints. The bus 1820 links together various circuits including one or more processors and/or hardware modules, represented by the controller or processor 1816, the modules or circuits 1804, 1806 and 1808, and the processor-readable storage medium 1818. One or more physical layer circuits and/or modules 1814 may be provided to support communications over a communication link implemented using a multi-wire bus 1812, through an antenna 1822 (to a radio access network for example), and so on. The bus 1820 may also link various other circuits such as timing sources, peripherals, voltage regulators, and power management circuits, which are well known in the art, and therefore, will not be described any further.

The processor 1816 is responsible for general processing, including the execution of software, code and/or instructions stored on the processor-readable storage medium 1818. The processor-readable storage medium may include a non-transitory storage medium. The software, when executed by the processor 1816, causes the processing circuit 1802 to perform the various functions described supra for any particular apparatus. The processor-readable storage medium may be used for storing data that is manipulated by the processor 1816 when executing software. The processing circuit 1802 further includes at least one of the modules 1804, 1806 and 1808. The modules 1804, 1806 and 1808 may be software modules running in the processor 1816, resident/stored in the processor-readable storage medium 1818, one or more hardware modules coupled to the processor 1816, or some combination thereof. The modules 1804, 1806 and 1808 may include microcontroller instructions, state machine configuration parameters, or some combination thereof.

In one configuration, the apparatus 1800 includes modules and/or circuits 1808 configured to provide, encode, decode and otherwise process data frames, modules and/or circuits 1806 adapted to reconfigure one or more lanes and/or channels of a multilane serial bus, and modules and/or circuits 1804 configured to initiate and participate in bus arbitration procedures, which may include bus request assertions.

In one example, the apparatus 1800 includes a bus interface coupled to a processor 1816 and a serial bus that has a clock lane and a primary data lane. The processor 1816 may be configured to assert a multilane bus request by causing the interface circuit to initiate a pulse on a secondary data lane of the serial bus while the clock lane is idle, participate in a first bus arbitration procedure executed using the secondary data lane after the pulse is terminated, cause the interface circuit to provide a first SSC on the secondary data lane after winning the first bus arbitration procedure to indicate a set of data lanes to be used during a transaction, and execute a first transaction using the set of data lanes. The set of data lanes may include the primary data lane and the secondary data lane. The set of data lanes may include at least one additional data lane.

In some instances, the processor is further configured to assert a single-lane bus request by causing the interface circuit to initiate a pulse on the primary data lane after the first transaction has been completed, participate in a second bus arbitration procedure executed using the primary data lane after the pulse is terminated, and execute a second transaction using the primary data lane.

In various examples, the processor is further configured to cause the interface circuit to provide a second SSC on at least one additional data lane while providing the first SSC on the secondary data lane, and execute the first transaction by transmitting a data payload using two or more channels, each channel including one or more data lanes. The processor may be further configured to configure the two or more channels based on an enumeration of the secondary data lane and the at least one additional data lane. The processor may be further configured to cause the interface circuit to interleave one or more frames in the data payload over the one or more data lanes of at least one channel. The processor may be further configured to transmit a first portion of the data payload over a first channel to a first device coupled to the serial bus, and transmit a second portion of the data payload over a second channel to a second device coupled to the serial bus.

In certain examples, the processor is further configured to cause the interface circuit to initiate a pulse on the primary data lane while initiating the pulse on the secondary data lane. The presence of pulses on the primary data lane and the secondary data lane may be transmitted to indicate that the multilane bus request is a high-priority bus request. The set of data lanes may include a maximum number of data lanes available for executing the first transaction in response to the high-priority request.

The apparatus 1800 may include one or more multiplexers and/or demultiplexers configured to select a combination of application data, power management information and/or VGI state information to be communicated over one or more of the data lanes.

The processor-readable storage medium 1818 may store instructions which, when executed by at least one processor or state machine of the processing circuit 1802, cause the processor and/or processing circuit 1802 to assert a multilane bus request by initiating a pulse on a secondary data lane of the serial bus while the clock lane is idle, participate in a first bus arbitration procedure executed using the secondary data lane after the pulse is terminated, provide a first SSC on the secondary data lane after winning the first bus arbitration procedure to indicate a set of data lanes to be used during a transaction, and execute a first transaction using the set of data lanes. The set of data lanes may include the primary data lane and the secondary data lane. The set of data lanes may include at least one additional data lane.

The storage medium may include instructions that cause the processing circuit to assert a single-lane bus request by initiating a pulse on the primary data lane after the first transaction has been completed, participate in a second bus arbitration procedure executed using the primary data lane after the pulse is terminated, and execute a second transaction using the primary data lane.

The storage medium may include instructions that cause the processing circuit to provide a second SSC on at least one other data lane while providing the first SSC on the secondary data lane, and execute the first transaction by transmitting a data payload using two or more channels, each channel including one or more data lanes. The storage medium may include instructions that cause the processing circuit to configure the two or more channels based on an enumeration of the secondary data lane and the at least one other data lane. The storage medium may include instructions that cause the processing circuit to interleave one or more frames in the data payload over the one or more data lanes of at least one channel. The storage medium may include instructions that cause the processing circuit to transmit a first portion of the data payload over a first channel to a first device coupled to the serial bus, and transmit a second portion of the data payload over a second channel to a second device coupled to the serial bus.

The storage medium may include instructions that cause the processing circuit to initiate a pulse on the primary data lane while initiating the pulse on the secondary data lane. The presence of pulses on the primary data lane and the secondary data lane may indicate that the multilane bus request is a high-priority request. The set of data lanes may include a maximum number of data lanes available for executing the first transaction in response to the high-priority request.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a device coupled to a serial bus that has a clock lane and a primary data lane, comprising:
asserting a multilane bus request by initiating a first pulse on a secondary data lane of the serial bus while the clock lane is idle;
participating in a first bus arbitration procedure executed using the secondary data lane after the first pulse is terminated;
providing first signaling on the secondary data lane after winning the first bus arbitration procedure to indicate a set of data lanes to be used during a transaction; and
executing a first transaction using the set of data lanes, wherein the set of data lanes includes the primary data lane and the secondary data lane, and wherein executing the first transaction includes transmitting data over the primary data lane and over the secondary data lane in accordance with timing provided by a clock signal transmitted over the clock lane.

2. The method of claim 1, further comprising:
asserting a single-lane bus request by initiating a second pulse on the primary data lane after the first transaction has been completed;
participating in a second bus arbitration procedure executed using the primary data lane after the second pulse is terminated; and
executing a second transaction using the primary data lane.

3. The method of claim 1, further comprising:
providing second signaling on at least one additional data lane while providing the first signaling on the secondary data lane; and
executing the first transaction by transmitting a data payload using two or more channels, each channel including one or more data lanes.

4. The method of claim 3, wherein the first signaling comprises a first sequence start condition (SSC), and wherein the second signaling comprises a second SSC.

5. The method of claim 3, further comprising:
configuring the two or more channels based on an enumeration of the secondary data lane and the at least one additional data lane.

6. The method of claim 3, further comprising:
interleaving one or more frames in the data payload over one or more data lanes of at least one channel.

7. The method of claim 3, further comprising:
transmitting a first portion of the data payload over a first channel to a first device coupled to the serial bus; and
transmitting a second portion of the data payload over a second channel to a second device coupled to the serial bus.

8. The method of claim 1, further comprising:
initiating a second pulse on the primary data lane while initiating the first pulse on the secondary data lane,
wherein presence of the second pulse on the primary data lane and the first pulse on the secondary data lane indicates that the multilane bus request is a high-priority request.

9. The method of claim 8, wherein the set of data lanes comprises a maximum number of data lanes available for executing the first transaction in response to the high-priority request.

10. The method of claim 1, wherein executing the first transaction comprises:
transmitting virtualized general-purpose input/output state.

11. An apparatus, comprising:
an interface circuit coupled to a serial bus that has a clock lane and a primary data lane; and
a processor configured to:
assert a multilane bus request by causing the interface circuit to initiate a first pulse on a secondary data lane of the serial bus while the clock lane is idle;
participate in a first bus arbitration procedure executed using the secondary data lane after the first pulse is terminated;
cause the interface circuit to provide first signaling on the secondary data lane after winning the first bus arbitration procedure to indicate a set of data lanes to be used during a transaction; and
execute a first transaction using the set of data lanes, wherein the set of data lanes includes the primary data lane and the secondary data lane, and wherein the first transaction is executed by transmitting data over the primary data lane and over the secondary data lane in accordance with timing provided by a clock signal transmitted over the clock lane.

12. The apparatus of claim 11, wherein the processor is further configured to:
assert a single-lane bus request by causing the interface circuit to initiate a second pulse on the primary data lane after the first transaction has been completed;
participate in a second bus arbitration procedure executed using the primary data lane after the second pulse is terminated; and
execute a second transaction using the primary data lane.

13. The apparatus of claim 11, wherein the processor is further configured to:
cause the interface circuit to provide second signaling on at least one additional data lane while providing the first signaling on the secondary data lane; and
execute the first transaction by transmitting a data payload using two or more channels, each channel including one or more data lanes.

14. The apparatus of claim 13, wherein the first signaling comprises a first sequence start condition (SSC), and wherein the second signaling comprises a second SSC.

15. The apparatus of claim 13, wherein the processor is further configured to:
configure the two or more channels based on an enumeration of the secondary data lane and the at least one additional data lane.

16. The apparatus of claim 13, wherein the processor is further configured to:
cause the interface circuit to interleave one or more frames in the data payload over one or more data lanes of at least one channel.

17. The apparatus of claim 13, wherein the processor is further configured to:
transmit a first portion of the data payload over a first channel to a first device coupled to the serial bus; and
transmit a second portion of the data payload over a second channel to a second device coupled to the serial bus.

18. The apparatus of claim 11, wherein the processor is further configured to:
cause the interface circuit to initiate a second pulse on the primary data lane while initiating the first pulse on the secondary data lane,
wherein presence of the second pulse on the primary data lane and the first pulse on the secondary data lane indicates that the multilane bus request is a high-priority request.

19. The apparatus of claim 18, wherein the set of data lanes comprises a maximum number of data lanes available for executing the first transaction in response to the high-priority request.

20. The apparatus of claim 11, wherein the processor is further configured to:
transmit virtualized general-purpose input/output state in the first transaction.

21. A non-transitory processor-readable storage medium having one or more instructions that, when executed by at least one processor of a processing circuit, cause the processing circuit to:
assert a multilane bus request by initiating a first pulse on a secondary data lane of a serial bus while a clock lane of the serial bus is idle;
participate in a first bus arbitration procedure executed using the secondary data lane after the first pulse is terminated;
provide first signaling on the secondary data lane after winning the first bus arbitration procedure to indicate a set of data lanes to be used during a transaction; and
execute a first transaction using the set of data lanes, wherein the set of data lanes includes a primary data lane and the secondary data lane, and wherein the first transaction is executed by transmitting data over the primary data lane and over the secondary data lane in accordance with timing provided by a clock signal transmitted over the clock lane.

22. The storage medium of claim 21, further comprising instructions that cause the processing circuit to:
assert a single-lane bus request by initiating a second pulse on the primary data lane after the first transaction has been completed;
participate in a second bus arbitration procedure executed using the primary data lane after the second pulse is terminated; and
execute a second transaction using the primary data lane.

23. The storage medium of claim 21, further comprising instructions that cause the processing circuit to:
provide second signaling on at least one additional data lane while providing the first signaling on the secondary data lane; and
execute the first transaction by transmitting a data payload using two or more channels, each channel including one or more data lanes.

24. The storage medium of claim 23, wherein the first signaling comprises a first sequence start condition (SSC), and wherein the second signaling comprises a second SSC.

25. The storage medium of claim 23, further comprising instructions that cause the processing circuit to:
configure the two or more channels based on an enumeration of the secondary data lane and the at least one additional data lane.

26. The storage medium of claim 23, further comprising instructions that cause the processing circuit to:
interleave one or more frames in the data payload over one or more data lanes of at least one channel.

27. The storage medium of claim 23, further comprising instructions that cause the processing circuit to:
transmit a first portion of the data payload over a first channel to a first device coupled to the serial bus; and
transmit a second portion of the data payload over a second channel to a second device coupled to the serial bus.

28. The storage medium of claim 21, further comprising instructions that cause the processing circuit to:
initiating a second pulse on the primary data lane while initiating the pulse on the secondary data lane,
wherein presence of the second pulse on the primary data lane and the first pulse on the secondary data lane indicates that the multilane bus request is a high-priority request.

29. The storage medium of claim 28, wherein the set of data lanes comprises a maximum number of data lanes available for executing the first transaction in response to the high-priority request.

30. The storage medium of claim 21, further comprising instructions that cause the processing circuit to:
transmit virtualized general-purpose input/output state in the first transaction.
